(19) United States
(12) Patent Application Publication
(10) Pub. No.: US 2014/0136838 A1
(43) Pub. Date: May 15, 2014

(54) ENTITY NETWORK TRANSLATION (ENT)

(71) Applicant: Timothy Mossbarger, La Mesa, CA (US)

(72) Inventor: Timothy Mossbarger, La Mesa, CA (US)

(21) Appl. No.: 14/075,486

(22) Filed: Nov. 8, 2013

Related U.S. Application Data
(60) Provisional application No. 61/724,763, filed on Nov. 9, 2012.

(51) Int. Cl. H04L 9/32

(52) U.S. Cl. CPC H04L 9/3263
USPC 713/156

(57) ABSTRACT

The present invention provides an Entity Network Translation (ENT) scheme for identifying and authenticating abstract identities using public-private key technology and PKI concepts such as a certificate authority and certificate chaining. ENT may grant any number of authentic, indefinite, abstract identifiers to any number of requestors. These abstract identifiers are each referred to as a verinym, which loosely means “verified name”. They allow any person or entity, for any purpose, to establish and control the authentic identities of things electronically, and establish relationships between these identities. According to some embodiments, ENT sidesteps traditional PKI relationship establishment issues by issuing abstract identifiers to users that request them. It is the use of these abstract identifiers, and the relationships formed between entities that define their real-world significance.

### CROSS-REFERENCE TO RELATED APPLICATION

The present application claims priority to U.S. Provisional Patent Application No. 61/724,763, filed on Nov. 9, 2012, entitled “System and Methods for Entity Network Translation (ENT),” the entire disclosure of which is incorporated by reference herein.

### BACKGROUND OF THE INVENTION

1. Field of Invention

This invention relates to applied cryptography and, more specifically, to digital certificates for identifying and authenticating abstract identities of persons, entities, and electronic devices.

2. Description of Related Art

Secure access to systems containing sensitive and/or confidential information is a well-known and established practice. For example, a bank customer may access information about their bank accounts through a secure website. Such secure access is commonly provided by a public-key infrastructure (PKI), which is a set of hardware, software, people, policies, and procedures needed to create, manage, distribute, use, store, and revoke digital certificates that are used in providing secure access to systems. A digital certificate is an electronic document that uses a digital signature to bind a public key with an identity. Public-key cryptography is a cryptographic technique used with PM that enables users to securely communicate on an insecure public network, such as the Internet, and to verify the identity of a user via digital signatures. The PM creates digital certificates which map public keys to entities, securely stores these certificates in a central repository, and revokes them if needed. A PKI generally includes a certificate authority (CA) that both issues and verifies the digital certificates, a registration authority which verifies the identity of users requesting information from the CA, a central directory to store and index keys, and a certificate management system.

In traditional PKI systems, certificates issued contain information linked directly to an identity. If a certificate is issued to an individual, for instance, the certificate is conceptually interchangeable with the identity of the individual in electronic terms.

### SUMMARY OF THE INVENTION

The present invention provides a technique for Entity Network Translation (ENT). ENT is a scheme for identifying and authenticating abstract identities using public-private key technology and PKI concepts such as a certificate authority and certificate chaining. ENT may grant any number of authentic, indefinite, abstract identifiers to any number of requestors. These abstract identifiers are each referred to as a verinym, which loosely means “verified name”. They allow any person or entity, for any purpose, to establish and control the authentic identities of things electronically, and establish relationships between these identities. According to some embodiments, ENT sidesteps traditional PM relationship establishment issues by issuing abstract identifiers to users that request them. It is the use of these abstract identifiers, and the relationships formed between entities that define their real-world significance.

As mentioned above, in traditional PKI systems, certificates issued contain information linked directly to an identity. If a certificate is issued to an individual, for instance, the certificate is conceptually interchangeable with the identity of the individual in electronic terms. According to embodiments of the present invention, in ENT this linkage is not assumed. It may not be assumed that a verinym is linked to any specific use or context at all. Instead, a verinym allows trusted relationships to be established and maintained stably between parties for arbitrary purposes. This is a subtle but important difference from existing PKI solutions. ENT allows real-world relationships to be established, but does not imply that they are real-world identities. A relationship can have many specific rules for establishment. A bank needs certain information to establish a relationship with a customer. A gaming site may need other information. A social network may have yet different criteria. The processes for the establishment of these relationships are specific to the problem domain. According to embodiments of the present invention, however, verinyms are abstract.

The use of a verinym, in various embodiments, is determined by the requestor. Usage may include online identities with exceptional security for individuals, computers and devices, identification and control of programs, identification of companies or groups of individuals, etc. According to embodiments of the present invention, ENT may provide value through its ability to be used across all of these problem domains and more without requiring domain specific technology. ENT may reduce or eliminate many of these domain specific solutions with a standardized generic solution. Further, ENT may allow sharing of information, access, command and control, and so on using generic ENT interfaces and mechanisms across problem domains. This makes it possible to identify everything that connects or interacts electronically, whether it be a person, company, computer program, device, artificial intelligence, etc.

In an embodiment of the invention, a method for creating a unique identifier for a person, entity, or electronic device, the method implemented within a group authority structure comprising a number (N) of root servers greater than one and comprises the steps of: receiving, at a first root server, a request from a requester for a unique identifier; issuing, at the first root server, a first certificate comprising a unique identifier and a policy, wherein the policy comprises one or more other unique identifiers and at least one Boolean operator or mathematical function if the number of other identifiers in the policy is greater than one; signing, at the first root server, the issued first certificate with a private key from a public/private key pair associated with the root server; transmitting, from the first root server, the signed issued first certificate, to each other root server; validating, at each other root server, the abstract unique identifier of the signed issued first certificate; issuing, at each other root server, an additional certificate comprising the unique identifier and the policy; signing, at each other root server, the issued additional certificate with a private key from a public/private key pair associated with the respective other root server; and storing, at a data repository, the signed issued first certificate and the signed issued additional certificates to the requester. N is an odd number and each root server signs and operates independently of all other root servers. No two root computer servers may issue a same abstract unique identifier to two different requesters. Each root server is authorized to issue an exclusive range of unique identifiers. The signed issued first certificate and the signed issued additional certificates to the requester do not include any description or identification of the requester. The abstract unique identifier is considered valid when a number (X) of the signed issued first certificate and the signed issued additional certificates are valid, wherein X=N/2+1. The request further comprises the policy. The method may further comprise the steps of: receiving, at the root servers, a renewal request for renewal of the unique identifier in the first issued certificate, wherein the renewal request is signed by each person, entity, or electronic device associated with the other unique identifiers with a private key; validating, at each root server, the renewal request through execution of the policy in the first issued certificate; issuing, at each root server, a replacement certificate to replace the first issued certificate; signing, at each root server, the replacement certificate with a private key from a public/private key pair associated with the respective root server; and storing, at a data repository, the signed issued replacement certificate. The group authority automates enforcement of the policy. The first issued certificate comprises a public key or identification of a public key associated with the requester. The policy comprises a policy for replacing or updating the unique identifier. The policy comprises a policy for authenticating the unique identifier.

In another embodiment of the invention, a method for creating a unique identifier for a person, entity, or electronic device, the method implemented on a server and comprises the steps of: receiving, at the server, a request from a requester for a unique identifier; issuing, at the server, a first certificate comprising a unique identifier and a policy, wherein the policy comprises one or more other unique identifiers and at least one Boolean operator or mathematical function if the number of other identifiers in the policy is greater than one; signing, at the server, the issued first certificate with a private key from a public/private key pair associated with the server; and storing, at a data repository, the signed issued first certificate. The signed issued first certificate does not include any description or identification of the requester. The request further comprises the policy.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates entities and relationships among the entities according to an embodiment of the invention;

FIG. 2 illustrates a process for creating self-signed and cross-signed certificates according to an embodiment of the invention;

FIG. 3 illustrates a process for creating self-signed and cross-signed certificates according to another embodiment of the invention;

FIG. 4 illustrates an initial authorized group and an unauthorized group that may access an entity according to an embodiment of the invention;

FIG. 5.1 illustrates a process for replacing a certificate according to an embodiment of the invention;

FIG. 5.2 illustrates relationships among certificates utilized in the process of FIG. 5.1.

FIG. 6 illustrates self-signed and cross-signed certificates according to embodiment of the invention;

FIG. 7 illustrates relationships among certificates according to embodiment of the invention;

FIG. 8 illustrates entity relationships according to embodiment of the invention;

FIG. 9 illustrates self-signed and cross-signed certificates according to another embodiment of the invention;

FIG. 10 illustrates a cross-signed document of an authorized group according to another embodiment of the invention;

FIG. 11 illustrates a cross-signed document of a replacement authorized group according to another embodiment of the invention;

FIG. 12 illustrates a document containing algebra used to replace the document with a future document according to another embodiment of the invention;

FIG. 13 illustrates a process for creating certificates according to an embodiment of the invention;

FIG. 14 illustrates a group of entities according to an embodiment of the invention;

FIG. 15 illustrates an example JSON credential according to an embodiment of the invention;

FIG. 16 a process for creating a certificate according to an embodiment of the invention;

FIG. 17 illustrates a replacement request for a certificate, using peer signers, according to another embodiment of the invention;

FIG. 18 illustrates the replacement of a certificate in a store with another certificate with a larger serial number, according to another embodiment of the invention;

FIG. 19 illustrates the replacement of a certificate in a store with another certificate with a larger serial number, according to another embodiment of the invention; and

FIG. 20 illustrates a block diagram of an entity network translation (ENT) system according to one embodiment that includes user access terminals that may use the ENT system to access various other systems.

### DETAILED DESCRIPTION OF PREFERRED EMBODIMENTS

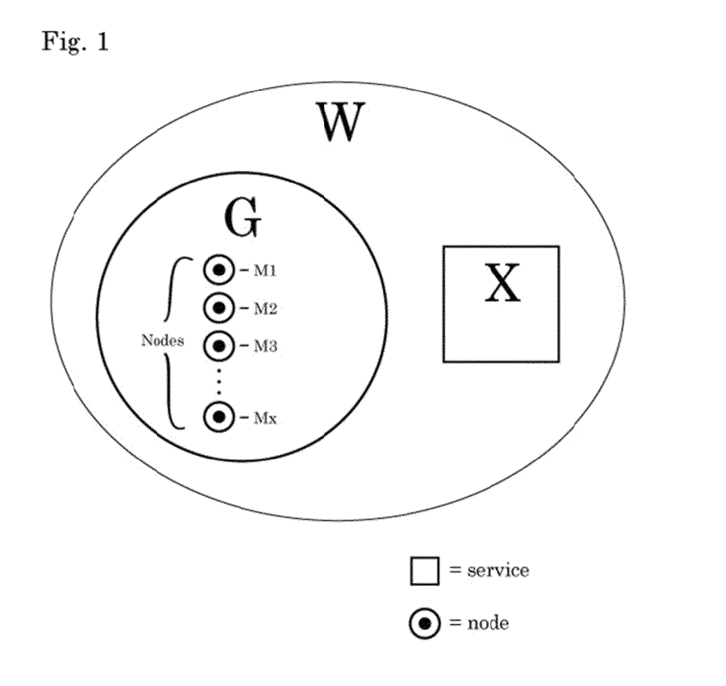

Preferred embodiments of the present invention and their advantages may be understood by referring to FIGS. 1-20, wherein like reference numerals refer to like elements. Various embodiments provide systems and methods for Entity Network Translation (ENT). According to embodiments, ENT is a PKI system. It utilizes private/public keys, central authority, certificates and certificate chaining It has also been designed to leverage existing technological infrastructure and cryptographic protocols and standards such as Transport Layer Security (TLS) and X.509, the practice of which is readily apparent to one of ordinary skill in the art. This allows ENT to be used in existing systems without (in most cases) direct modification to those systems. It is not a requirement that ENT use these existing technologies, but it may be helpful.

ENT, according to embodiments, is not a typical PM system. It was designed to allow heavy automation of all basic PKI activities, provide exceptional scalability, durability and auditing. Substantial research and development has been spent on achieving these goals. More formally, the goals of ENT, according to embodiments, are:

1. Create a “Canopy” of verinyms. ENT may ensure that these identities can be used for secure, authenticated communication between 3rd parties for arbitrary purposes. The set of all 3rd parties, each owning one or more verinym constitutes the canopy.

2. Provide industrial strength cryptography and PKI services on par or exceeding any existing production PKI systems. ENT may provide these services in a distributed manner, allowing for outages, loss of trunk security and other serious events that may affect system trust and stability, without compromising the uniqueness of the verinyms within the system.

3. Delegate direct control of each verinym to the owner allowing use for any purpose whatsoever. Once a verinym has been created, the ENT system no longer has any control over the use of that verinym other than periodic renewals of association with a given verinym which must be accompanied by cryptographic “proof of ownership” by the identity holder.

4. Provide these services redundantly, and as inexpensively as possible. Most PM systems currently in existence rely on hierarchical signing mechanisms with a single root certificate at their cores. This single point of failure produces PKI systems of extraordinary cost as any breach is catastrophic. Additional cost is incurred through systems that require personnel and real-world process. ENT may reduce costs without reductions in security through innovation. In fact, in many dimensions ENT is substantially more secure than existing designs at deeply reduced cost. In no dimension is ENT less secure than existing PKI systems.

5. Operate transparently allowing sanity and trust checks by users and auditors. This ensures that system security breaches, back-doors and other untrustworthy behavior cannot be hidden.

6. Ensure verinym usage is abstract and anonymous by default. Private systems can be used to build non-private systems. The reverse is not true.

### PKI Definitions:

A certificate is a cryptographically signed message containing a public key corresponding to a public/private key pair (PPK) and some additional arbitrary information, and a signature by a private key corresponding to a possibly different PPK. The “target” of that certificate is the PPK or holder of the public key in that certificate. The “signer” is the PPK or holder of the private key used to sign that certificate.

A certificate is considered “signed” if the private portion of a PPK was used to sign that certificate. For additional clarity a “target” of a certificate is defined as the PPK or owner of that PPK whose public key is in the certificate. A certificate is considered “self-signed” if the public key found in that certificate is the public portion of a PPK, and the signature of that certificate is the matching private portion of that PPK.

A certificate is considered “self-signed” if the public key found in that certificate is the public portion of a PPK, and the signature of that certificate was created using the matching private portion of that PPK.

As referred to herein, the PPK performing actions is referred to as the certificate containing the public portion of that PPK, since both refer to the same holder. For instance, if certificate A contains the public key for PPK P, then statements such as “If A signs certificate B” should be read as P signing B, since private keys are the device used to perform actions by the PPK holder. Since the public key portion of P is in A, this chaining and association is logical and more easily read.

Further, as referred to herein, the verb form of “target” denotes that the subject entity or PPK of that targeting has its public key in a certificate that was targeted. For instance, if certificate A contains PPK P, and certificate B contains PPK Q, then “A targets B” if the PPK corresponding to A (in this case P) signed any certificate containing the public key portion of Q. Anything “targeting” B would be any PPK that signed a certificate containing the public portion of Q. “A targets B” and “B is targeted by A” are synonymous.

Note that asymmetric cryptography includes technologies such as ECC, RSA, and others, the identification and implementation of which are apparent to one of ordinary skill in the art, but also includes zero-knowledge proof mechanisms. In these cases signing is not possible, but a transaction that proves ownership of secrets is. Thus we can think of asymmetric cryptography for our purposes as any technology that is able to prove authenticity either through signing, transaction, or other mechanism. The mechanisms of these technologies are beyond the scope of this disclosure and readily understood by one of ordinary skill in the art.

### Group Command and Control:

In a traditional PM system, as is well known, there is a central server called a Certificate Authority (CA), that issues certificates and performs certificate related tasks. This central server contains a PPK that represents the CA. This PPK cryptographic primitive is used to sign and issue certificates, revocations or renewals. If the CA or the CA's PPK is compromised, the entire PKI system becomes compromised. Before examining specific embodiments of implementations of the equivalent of a CA in ENT, a conceptualization of a novel technology called Group Command and Control is described.

Group Command and Control is defined as a group of members, each of which control a PPK, that form a single conceptual entity that issues commands and handles the business of the group without being limited to a single key or a single point of failure. The group can suffer loss to a threshold without compromise of the conceptual entity, allowing robust long term stability by allowing group members to be replaceable. By supporting a system in which multiple group members each use PPKs with different security protocols and process, the risk of catastrophic failure is further reduced. Examples of group members could be multiple devices with a single owner, multiple users acting as a group, or more abstract concepts such as groups of groups of users, etc.

One value of this concept is the reduction of damage due to loss of control of PPKs through the use of multiple PPKs in a unique system that allows a group of nodes to act as a single entity. Damage may be prevented even if certain primitives are compromised or lost. Additional reduction of risk can be achieved through use of a heterogeneous system comprised of a multiplicity of cryptographic primitives. For instance, one node could use the RSA encryption process. Another could use DSA. Another could use Elliptical-curve. The limit of different process used is the limit of the number of nodes in the group.

With reference now to FIG. 1, a more detailed discussion is provided. Define a group with N member nodes called G that represents a virtual entity. This virtual entity could have an identifier of its own, or the identifier could be a collation of its members, such as by ordering all of its member node names, hashing that value, and using the hash as the identifier. Define a group W consisting of all devices or external parties that allow entity G to perform command and control. This control could be access to data, execution of code, or any other action that a member of W would like to authenticate G for. That is, members of W would like to allow action for group G and prevent action for any other group. Define a node Mx as the xth member of G. Mx nodes wield PPKs to accomplish group G goals. Define X as a user in W. In one implementation, N is always an odd number. This prevents an attacker from deadlocking the system if they capture exactly N/2 nodes and N was even.

In one embodiment, a single Mx node is given “tie-breaker” authority. In this case an even number of nodes is allowed. If an attacker captured N/2 nodes where N was even, the tie-breaker node would prevent a deadlock. The tie-breaker Mx node may always be the same node, or may vary depending on the members of G. For example, the oldest member of G could be the tie-breaker for G. Alternately, the newest member of G could be given tie-breaker status. Implementations may vary according to other embodiments.

With continued reference to FIG. 1, G uses asymmetric cryptography as the technology, in some embodiments. In one implementation PM constructs, such as X.509, certificates could be used. Some embodiments may use more modern data-interchange formats such as, but not limited to JavaScript Object Notation (JSON) or eXtensible Markup Language (XML) formats, the implementation of which are apparent to one of ordinary skill in the art.

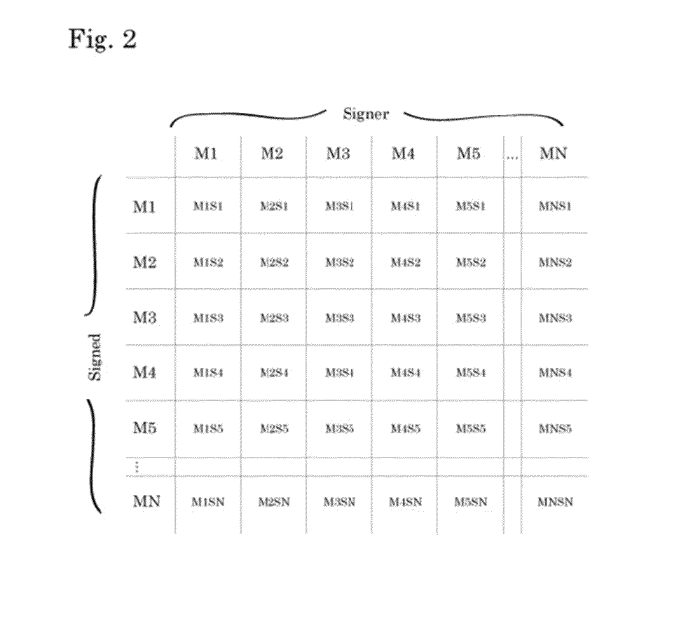

In one implementation the following steps are taken, as illustrated in FIG. 2: (1) Each Mx creates a private key, and a self-signed certificate MxSx (with said key) using an asymmetric cryptographic primitive; (2) Each Mx signs each other My's certificate. Define one of these certificates as MxSy. For example, if N was 3 then M1 would sign the certificates of M2 and M3 (creating M1S2 and M1S3), M2 would create M2S3 and M2S1, and M3 would create certificates M3S1 and M3S2. For N=3, there would be 3 self-signed certificates (step 1) and 6 cross-signatures for G (step 2); and (3) Define GC as the total set of certificates from step 2 for all Mx nodes, including each self-signed MxSx. Thus, for any G of size N there would be N self-signed certificates, N nodes, and (N−1)*(N−1) cross-signatures, yielding a total of N*N total certificates in the set GC

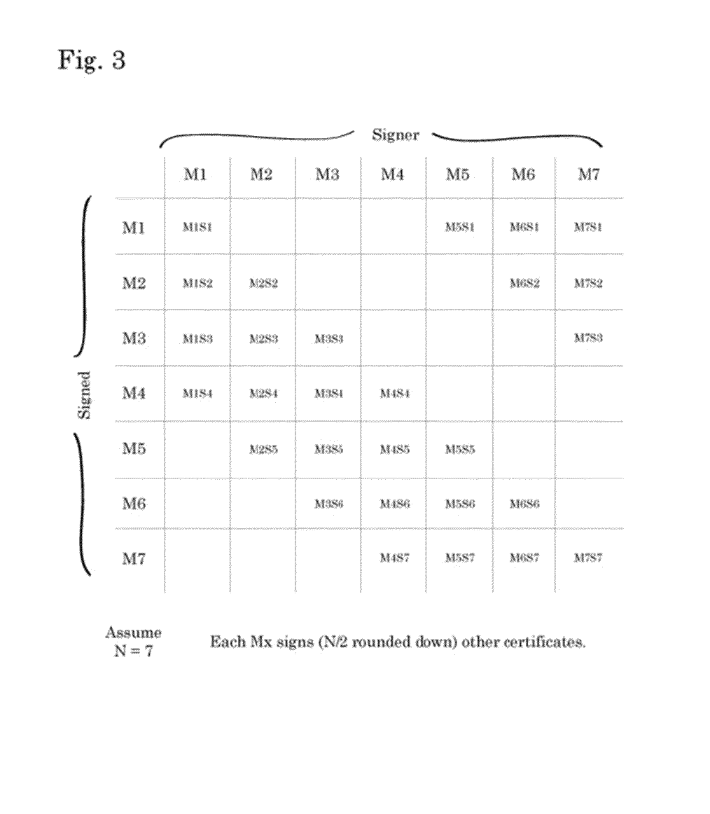

In one implementation each Mx signs just N/2 (rounded down) certificates instead of N−1 certificates using a “round robin” process. In this case, order all certificates created by an Mx into a list L using some deterministic ordering process such that M1 is always “before” M2, etc. This set would comprise GC. The N/2 certificates signed by Mx are the next greater N/2 (round up) certificates. If this calculation would extend past the end of the list, then the calculation should continue at the start of the list when there are no more certificates in L. For instance, for N=4, M1 would sign certificates for M2 and M3, and M4 would sign certificates for M1 and M2. M3 would sign certificates for M4 and M1. This set would comprise GC. FIG. 3 illustrates an example of such a round robin signature technique where N=7.

In one implementation, each Mx signs N−1 certificates. That is, each Mx creates N−1 certificates targeting each other unique My. In one implementation each Mx in G may use a different asymmetric cryptographic process. For instance, if N was 3 then one node could use an RSA key pair, one use a DSA key pair, and one use elliptical-curve cryptography. In one implementation, each Mx uses a certificate signed by a CA, instead of creating self-signed certificates. In all of these implementations, GC consists of a list of certificates, either self-signed or cross-signed such that for any MxSx in G, there are greater than N/2 signed certificates. That is, for each node Mx there are always N/2+1 signed certificates containing the PPK used by Mx. GC can now be examined for use by X when interacting with G.

X must be given an initial local copy of GC. It is important that X have GC in a local store before X can perform any actions. Call X's set of stored certificates T. A local store or copy is a portion of computer memory such as RAM or disk memory that contains data. In this case that storage contains T.

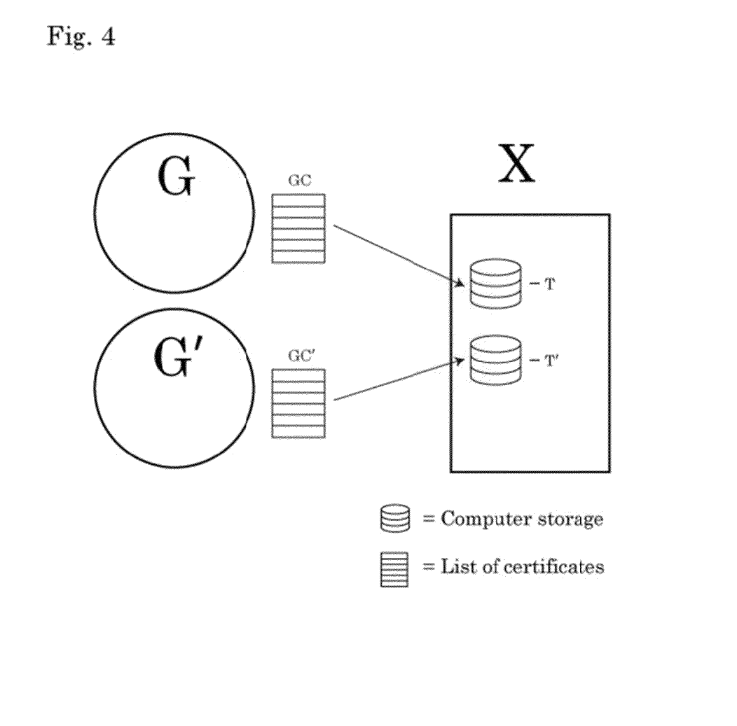

Referring to FIG. 4, in one implementation X receives GC when G originally requested services from X. At this time X could have requested GC as part of the service initialization. At the time of initialization, T=GC. That is, the trusted store contains exactly GC. Since there was no previous version of GC and X had no previous knowledge of G, passing GC to X on the initial communication is safe. For other G′ groups communicating with X, X would store a separate T′. Note that T′ is equivalent to a unique identifier for G′. This prevents an attacker from poisoning GC in the initial communication round. If an attacker submitted a modified T′ to X, G and T′ would mismatch. X would record T′ against G′ instead of G. When G then submitted T, X would not confuse G′ with G, and T′ with T. X would use T when contacted by G and T′ when contacted by the attacker.

Define a majority as a count which is greater than N/2, rounding up. Or, in the case where there is a tie-breaker, that the count is equal to or greater than N/2 and the tie-breaker is part of the count. Thus, for N=3, a majority would be 2. If N was 35, the majority would be 18.

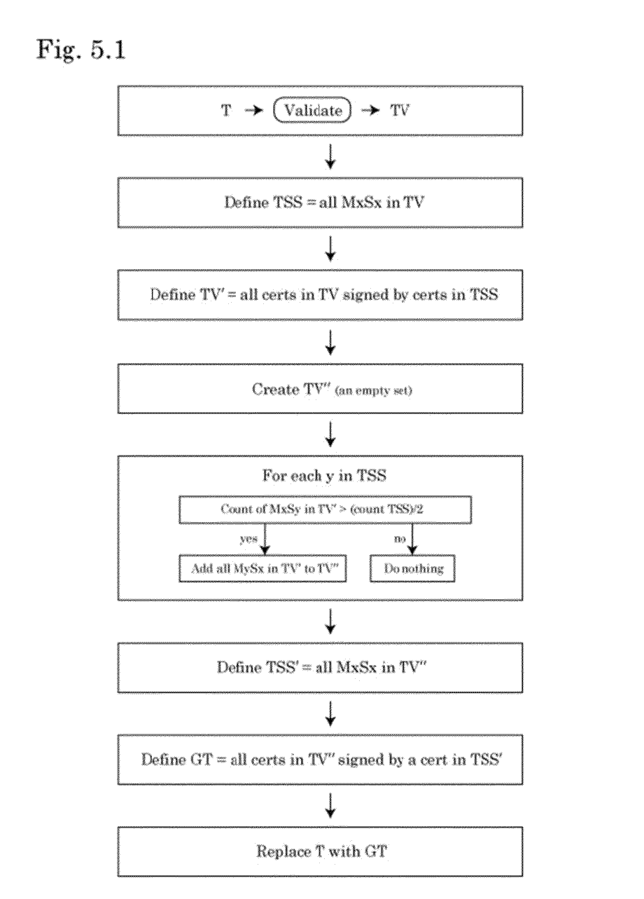

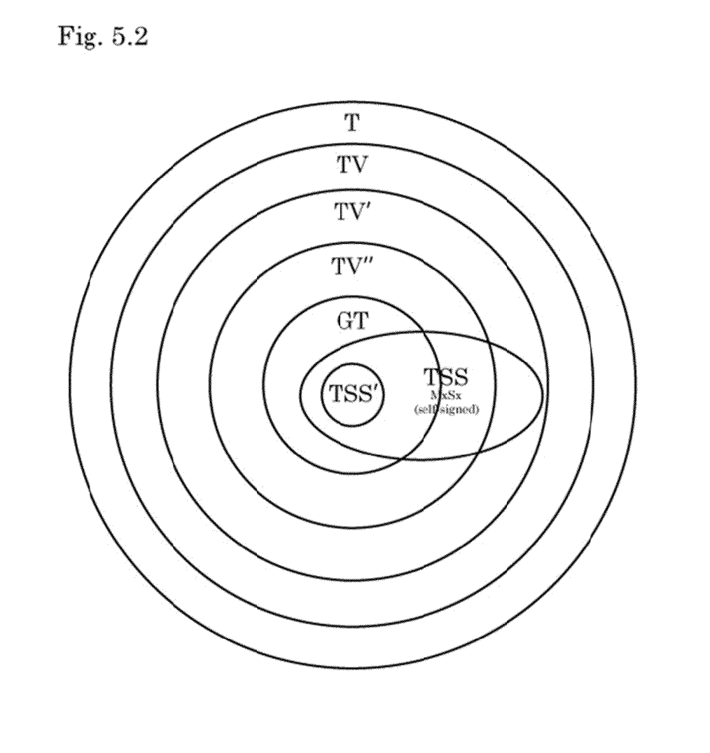

One particular implementation, referred to as ALGO1, is now described with reference to FIGS. 5.1 and 5.2. In this implementation, X can now validate that T is self-consistent in the following way:

1) X first calculates a set TV consisting of all valid certificates in T. A valid certificate is a certificate in T that:
a) is a self-signed certificate (MxSx) or
b) is cross-signed by an Mx (MxSy) in T whose self-signed certificate is in T and
c) meets any other certificate validity rules, such as expiry, not-valid-before, format, etc.

2) Define a set TSS of all MxSx certificates in TV that contain unique public keys.

3) Define a set TV′ containing all certificates in TV that were signed by any certificate in TSS. That is, TV′ contains any MxSy where MxSx is in TSS.

4) Create an empty set TV″.

5) For each certificate y in TSS, perform the following:
a) If the count of all MxSy in TV′ is a majority of certificates found in TSS, then add all certs MySx in TV′ to TV″. This should include all MySy (self-signed) certificates. Any My that does not have a majority of signatures from other Mx nodes will not be added to TV″ because of this step.

6) Create a set TSS′ containing all self-signed certificates in TV″.

7) Create a set GT containing all certificates found in TV″ signed by any certificate in TSS′. Certificates added to GT will not include certificates targeting Mx nodes that are not in TSS′.

8) X replaces T with GT.

In a typical implementation, initially T=GC=GT.

In practice, any valid certificate MxSp in T that was signed by a node with a valid MxSx in T, where node p did not have a MpSp in T would not be discarded. That certificate would be set aside for later use with ALGO2, which is described below. The point is that MxSx is trusted, and any certificates signed by x are also trusted but unused.

Note that Step 8 of ALGO1 allows X to trim certificates from T. That is, any certificates signed by a node which does not have the trust of a majority of nodes in G are discarded from T. Also note that ALGO1 mutates T. It requires a T input and produces a replacement T as output. If run repeatedly on any T, ALGO1 will reach an unchanging state after one iteration. That is, if ALGO1 takes a T as input and produces GT as output, any future iterations of ALGO1 on GT will produce GT exactly. ALGO1 is idempotent.

Note that ALGO1 can produce an empty T if there are not more than N/2 cross-targeted certificates for some set of nodes. It is vital that the initial GC passed to X contains a proper set of certificates. In one implementation this can be accomplished by setting GC to contain just a single self-signed certificate for a node in G, and then using ALGO2 and ALGO3 (discussed later) to “grow” T.

In one implementation, valid certificates in T are certificates containing an ‘expiry’ time value, and the current date-time (as calculated when ALGO1 runs) has not passed that time value. Certificates with ‘expiry’ time values in the past are considered invalid.

In one implementation, valid certificates in T are certificates containing a ‘valid-from’ time value, and the current date-time (as calculated when ALGO1 runs) has passed that time value. Certificates with ‘valid-from’ time values in the future are considered invalid.

Adding Nodes to G: In one implementation, nodes in G can create and add additional nodes to G by creating certificates using the following mechanism. These nodes can then be sent to members of W which can use ALGO2 to update their trusted stores.

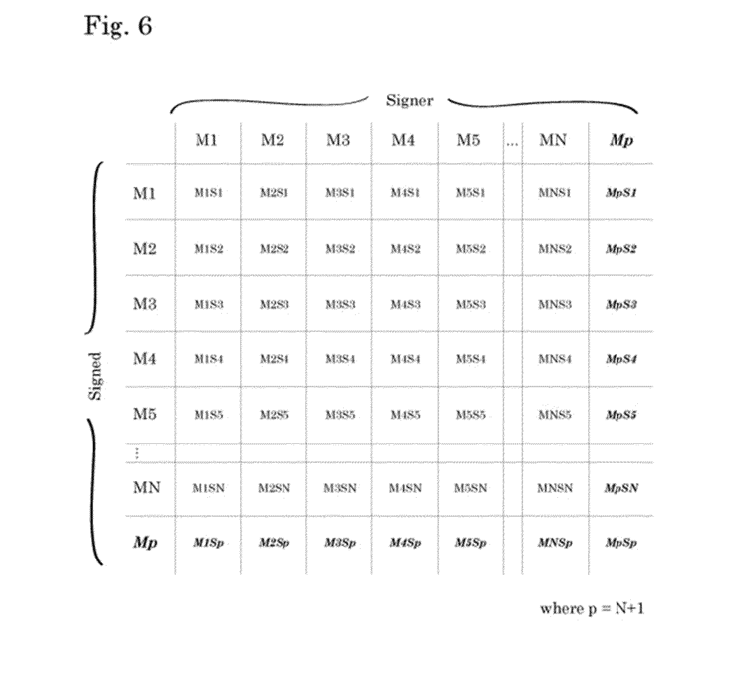

With reference now to FIG. 6, another process, referred to as ALGO3, is described. In this implementation, ALGO3 includes:

1) New node Mp creates a private key, and a self-signed certificate (MpSp) using an asymmetric cryptographic primitive.

2) Each node Mx in G creates an MxSp certificate.

3) Mp creates an MpSx certificate for each other node in G.

4) Define set IN consisting of the results of steps 1, 2 and 3. IN contains (N*2+1) certificates.

In one implementation, set IN may include certificates created by one or more new nodes. Also note that IN certificates sets sent by an attacker could arbitrary other incorrect certificates in addition to the proper certificates.

In one implementation, Mp nodes are always created in pairs. That is, there are always 2 Mp nodes created in ALGO3. This is vital when N is required to be odd. It is not necessary if a tie-breaker exists and N is even.

In one implementation, X can create a new T by adding certificates. This may be desirable as it allows X to securely redefine G to contain a larger number of nodes or replace nodes that are no longer in T because of validity. X receives a set of certificates IN. The following ALGO2 allows us to calculate what parts of IN should be added to T. This process allows us to also clear out incorrect certificates (sent by an attacker) before those certificates enter our trusted store T.

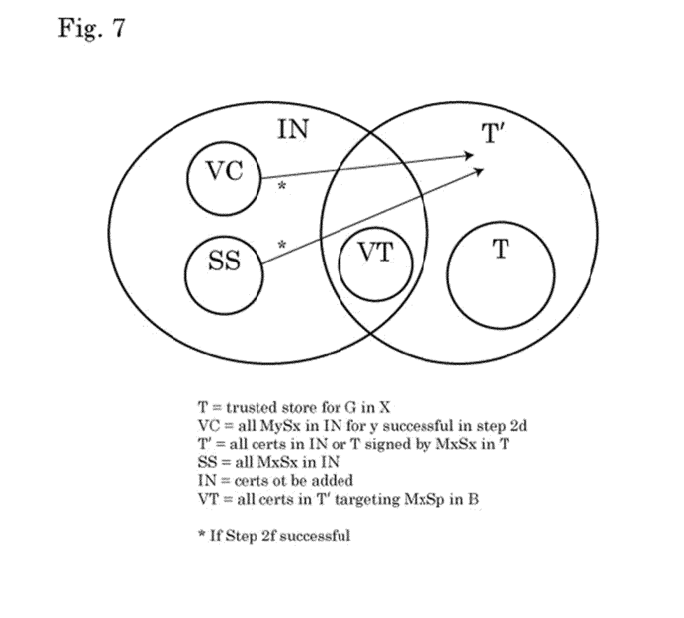

With reference now to FIG. 7, another process, referred to as ALGO2, is described. In this implementation, ALGO2 includes:

1) Create a set SS of MxSx certificates in IN. This is the set of all self-signed certificates in IN the that are being vetted for entry into T.

2) For each MySy certificate in SS (y being the node to be vetted):
a) Create set T of all certificates in T or IN signed by any MxSx in T. Since MxSx in T are trusted, T′ contains all certificates signed by trusted nodes present in either T or IN.
b) Create a set VT of all MxSy in T′. VT is the set of all trusted certificates targeting y.
c) Check validity of each certificate in VT using the same validity rules found in step 1 of ALGO1, discarding any invalid certificates from VT.
d) If the sum of the number of MxSx in T that signed any MxSy in VT is not a majority of all MxSx in T, repeat step 2 for next MySy in SS. In this case, y did was not vetted properly. A majority of trusted nodes did not create certificates vouching y.
e) Create a set VC of all MySx certificates in IN (where x is a node represented by MxSx in T). This is the set of all certificates signed by y that target trusted nodes in T.
f) If the sum of certs in VC is a majority of all MxSx in T, then add MySy and all certificates in VC to T′. If the vetted node y vouched for a majority of trusted nodes in T, then we add y's self-signed certificate to the trusted set T′ as well as all of its certificates targeting trusted nodes in T′.
g) Replace T with T′.

3) Perform ALGO1 on T.

ALGO2 allows the number of nodes in G, as known to X, to change, since T now contains certificates for those new nodes.

Removing Nodes from G: In addition to being able to add nodes to G, it is also beneficial to be able to remove nodes from G. In one implementation, nodes in G can remove a node Mp from G in the following way. Define a revocation certificate as a certificate containing a target for revocation (Mp), a signature by a node (Mx) in G, and a revocation value. In one implementation the revocation value is a certificate value field called “invalid”. The revocation value may be any value that X and members of G and W understand to mean that the target of that certificate is invalid. A valid revocation certificate is one that has a valid signature for Mx.

Another process, referred to as ALGO4, is now described. In this implementation, ALGO4 includes:

1) Create set GR of revocation certificates created by all Mx targeting Mp. Define MxRp as an arbitrary certificate in GR created by Mx and targeting Mp.

2) GR is distributed to X (and W in general).

In one implementation, X stores all such revocation certificates in certificate store TR.

In one implementation, valid certificates in T are certificates M×Mp for which there is no certificate MxRp in TR. That is, this implementation modifies step 1 in ALGO1 such that the existence of a valid MxRp in TR invalidates any MxSp in T. If there exists a certificate MxRp in TR and there exists a certificate MxSp in T then MxSp in T is no longer valid. In the preferred implementation, upon receiving some set of revocation certificates GR, X adds GR to TR, and performs ALGO1. In the preferred implementation X only adds certificates from GR to TR that were signed by an MxSx in T.

In one implementation, a revocation certificate MyRy (wherein an My node invalidates itself), all certificates signed by My should be considered invalid, including its MySy certificate. This allows a node to invalidate itself. In one implementation, this should not preclude Mx nodes from creating MxRy revocation certificates.

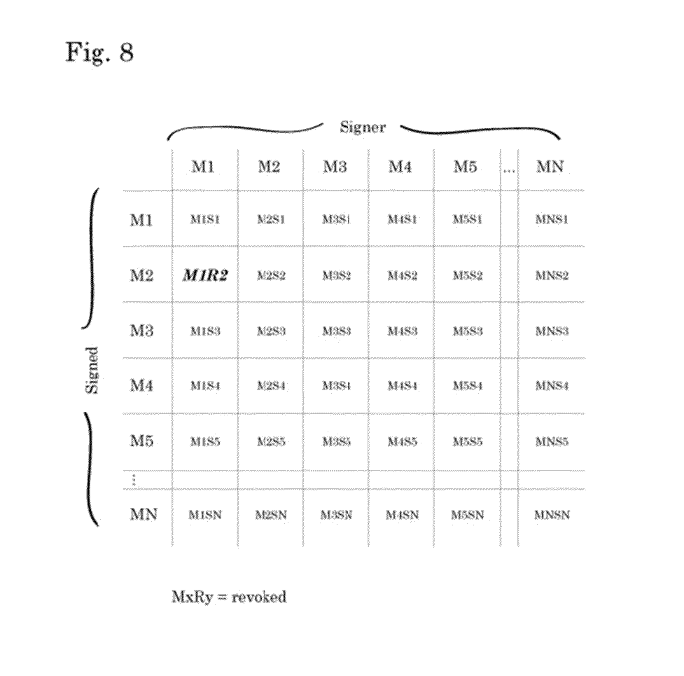

In one implementation, if each Mx uses a certificate signed by a CA, and that CA issues a revocation certificate for Mx, then X can invalidate each certificate signed by Mx, and remove all such certificates from T. In this case, X should store the CA's revocation certificate in TR. Note that this implementation adds another validity condition to step 1 of ALGO1. For example, FIG. 8 shows a map of the relationships between certificates when M1 has revoked M2 through certificate M1R2.

Using G to perform work: G can now request services from X in an authenticated way. Assume G wants to perform an action A with X. A is the action that X would like to authenticate against G. That is, to perform A, X would need a valid authentication that group G wanted that action accomplished.

In one implementation define Ax such that Ax is a message signed by an Mx authorizing action A. Define a set AG comprised of all Ax messages, where each Ax is signed by a corresponding unique Mx. For example, M1 signs A1, M2 signs A2 etc.

In one implementation an Mx node MInit initiates and manages the communication with X by collating signatures from all other Mx nodes in G.

Another process, referred to as ALGO4, is now described. In one implementation, X can authorize G to perform A in the following way:

1) X requests AG from MInit.

2) MInit signs Ax using its private key, and forwards A to all other Mx in G.

3) One or more of each Mx creates an Ax and returns these values to MInit.

4) MInit now holds AG. AG contains N or less signed messages, each from a unique Mx.

5) MInit sends AG to X.

6) X validates each Ax, ensuring that the command is valid, the signature is valid, and that the Mx signing Ax exists in T.

7) X sums the number of valid Ax messages from unique Mx nodes.

8) If the sum is a majority of all N self-signed certificates in T, then X authorizes the action.

In one implementation, MInit does not exist and each Mx sends Ax directly to X. In this case after X receives each Ax message from discreet Mx, run ALGO6.

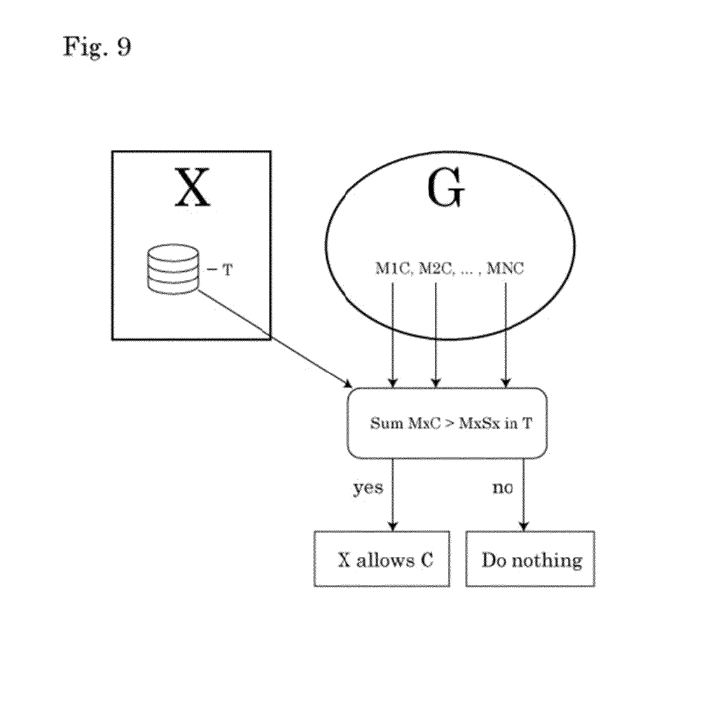

Another process, referred to as ALGO6, is now described, with reference to FIG. 9. In this implementation, ALGO6 includes:

1) Each Mx sends Ax to X

2) Each time X receives an Ax, X validates each Ax received thus far, ensuring that the command is valid, the signature is valid, and that the Mx signing Ax exists in T.

3) X sums the number of all such valid Ax messages from unique Mx nodes.

4) If the sum is a majority of MxSx certificates in T, then X authorizes the action.

Certificates are handled in sets or groups such as T and GC, and typical implementations certificates in these groups contain content parts that are identical when compared against other certificates in the same group. For instance, for all Mx in G, all MxSp certificates created for a given P contain identical information for Mp. This static content may be the action being authorized or the other certificates cross-signed by the certificate signer. Further, the same concept holds for signers of content. For a given P in G, all MpSx created by P are signed by P. Because of this symmetry, substantial reduction to the complexity of the above processes is possible if the certificates have knowledge of each other before cross signings occur. That is, that the agreement creation is synchronous and atomic between nodes. In many typical implementations, this is the case because it is true that nodes must agree with each other as to which members to include in G. Next we show the specific form of a simplified but equivalent method, and show that this signing and cross-signing is simply an authoritative agreement between a number of Mx in G.

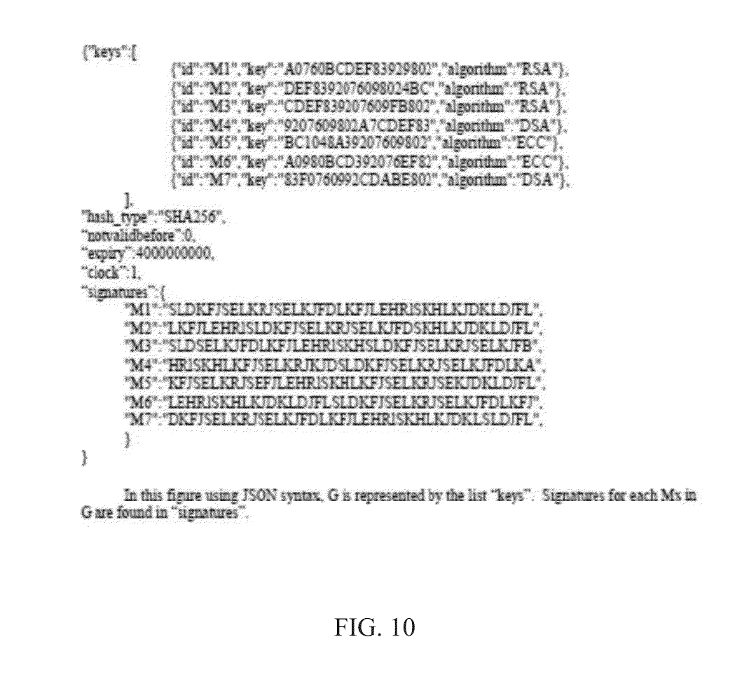

In one implementation using synchronous encoding, each Mx knows each other Mx in G to be cross-signed. A single set of public keys can be generated that identifies G. This list of keys can be signed by each Mx separately, and added to a single document that contains the list of public keys, and the signatures of each Mx in G. This produces a document D containing a list of allowed members of G, which is hashed and signed by each Mx in G, producing a second list with the same number of items (assuming all Mx signed) as depicted in JSON format in FIG. 10. In one implementation, D contains a “clock” integer value. In another implementation, a current time value can suffice as the “clock” value.

In some implementations, other validity values, such as expiry, not-valid-before, etc. may be present.

This encoding is quite efficient compared to the asynchronous certificate model above. For a G containing 7 members, the asynchronous approach yields 49 discrete asynchronous certificates, and requires processing via ALGO1 to validate. In the synchronous encoding, the same information is present including all self and cross signatures, but only 7 signatures for a single document are required. Further, T, GC, and GT contain only D. No additional certificates are required.

In one implementation, ALGO1 can be replaced by ALGO101, assuming D is present. In this case, T=D, D′=GC. In this implementation, all Mx members agree that a new D′ replacing D will have a “clock” value greater than the clock value held in T. That is, D′ documents that should replace older D documents will have a greater “clock” value.

ALGO101 includes:

1. Count all unique keys in D and define the total number divided by 2 (rounded up) as COUNT

2. Define a variable n, and set to zero.

3. For each signature in D′ increment n by 1 if the follow criteria are met:
a) ensure that signature matches a key found in the list of keys in D′
b) ensure that the signature matches a key found in the list of keys in D
c) ensure the signature correctly signed the list of keys in D′.

4. If n is greater than COUNT or n is equal to COUNT and the tiebreaker node completed step 3 correctly, than continue. Otherwise reject D′.

5. If the “clock” value in D′ is greater than the “clock” value of T, then continue. Otherwise reject D′.

6. D′ meets all validity and format requirements, including expiry, not-valid-before, etc. If one of these is not met, reject D′.

7. Replace D with D′.

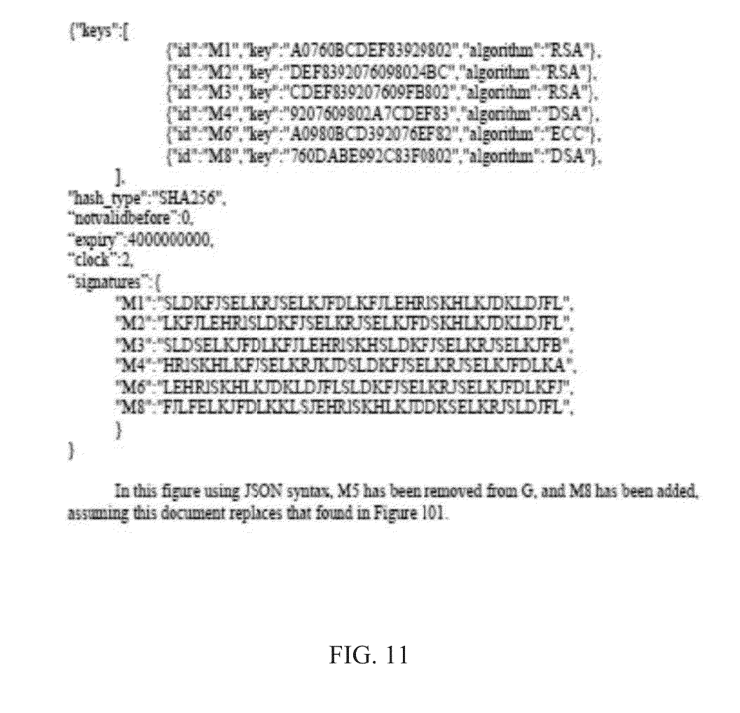

In some implementations, ALGO101 can also replace ALGO2, ALGO3, and ALGO4. That is, in our synchronous encoding case, adding or removing nodes into G and updating T can all function via ALGO101. Since a list of keys in D′ can contain either more or less keys, including keys for new Mx nodes, ALGO101 can modify T as well as validate it. In some implementations, if the “count” field is always incremented by 1 per topology change in G, a stream of D′ messages can update T in any X from any valid previous version of T. This can be accomplished by transmitting to X each D′ such that the D′ transmitted had a “count” value of exactly 1 higher than the D held by X. This allows for very simple and elegant synchronization of T across any number of X. For example, FIG. 11 replaces the D found in FIG. 10, assuming all signature and validity requirements were met.

In one implementation, ALGO5 may be modified to use synchronous encoding. In these cases, a single document AD is sent instead of message group AG. AD contains a list of signatures, and action A. validation of signatures happens against the signatures in AD instead of against individual Ax messages.

In some implementations, it is beneficial to have a partial set of Mx nodes be able to act as an authorizing agency, even if it is a minority. By adding an integer “quorum” field to D, we can use the quorum value instead of the COUNT value found in ALGO101. That is, instead of setting a strict majority, we can set the required number of nodes to an arbitrary value. For example, if G contained 7 nodes, we could set quorum to 2. In this case, ALGO101 would require more 2 or more signatures for D′ to be a valid replacement to D.

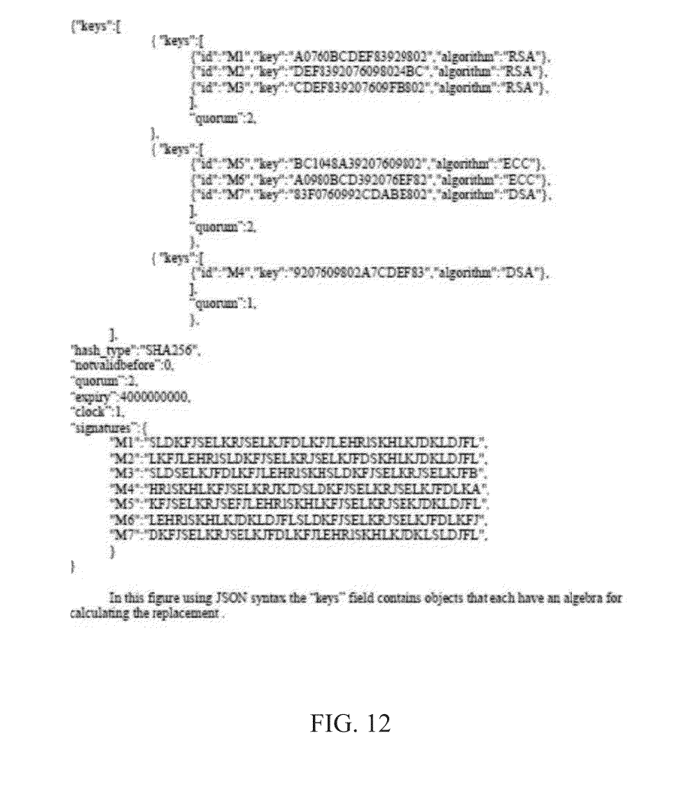

In some implementations, it is beneficial to have Mx nodes that are bucketized and grouped together into subgroups G′ to account for instances where certain Mx nodes are less secure than other nodes. In this case we can define a grouping syntax similar to that found in FIG. 12 called “buckets”.

In one implementation, each group in “buckets” GBx can be thought of a miniature group G. That is, G authorizes action based on the “quorum” field and the number of GBx buckets in G that evaluate to true, and each such bucket GBx is defined by its quorum value and the number of Mx in GBx. Further, each of these buckets can internally contain further bucket groups, as needed. This is a fractal representation of G, and allows arbitrary control of voting characteristics in G. To authorize a D′ as a replacement of D, ALGO101 is ran, but in a recursive manner, such that each bucket causes ALGO101 to be ran for that bucket. For example, the D found in FIG. 12 would allow replacement from a D′ that had M4 AND the majority of (M1 μM2 μM3) found in the signatures. D is also satisfied by a majority of (M1, M2, M3) AND the majority of (M5, M6, M7).

This implementation has the advantage of allowing a topology of G that is fine tuned for specific performance characteristics, load balancing, safety, and distribution characteristics more than is possible using a strict majority system. As we shall see in the Relational Authorization section, this principal can be further abstracted into a generic authorization algebra.

Creating a Group Authority using Group Command and Control:

Now that various implementations of a group command and control mechanism have been described, this mechanism may be applied to the creation of a concept called a Group Authority (GA). In ENT a GA is the equivalent of a Certificate Authority (CA) in traditional PKI systems. A GA may be described as follows, according to some embodiments.

Initially, define a PKI system PK, and user Ux, where Ux is an arbitrary user of the system. U1 would be user 1 etc. Define a private/public key pair UxPPK created by Ux where Ux holds the private key. For example, U1's PPK would be U1PPK. Ux may represent a certificate control officer whose duty is to manage certificates in PK. If Ux is such an officer, U1P would not likely be created by Ux, but by the originating user. In this case just substitute the officer for Ux, as this has no impact on the following implementations. Define a cryptographic process CAL, this is the asymmetric cryptographic technology used.

Create a group G of N nodes. Create a certificate store GC by using mechanism outlined above in the “Group Command and Control” section. According to those rules, G can issue commands as a single entity. Define an arbitrary node Mx in G where each Mx has a self-signed certificate and cross-signed certificates in GC. For example M1 would be node 1 in G.

Each node Mx can sign certificates containing the public portion of UxPPK. Each such signed certificate must contain a unique combination of certificate fields such that the certificate can be defined as identifying a unique party Ux such that Mx will not create more than one unique signed certificate per Ux. Define this certificate as UxC. In one implementation, all such certificates can be combined into a single document UC per the synchronous method in the Group Command and Control section.

In one implementation, one skilled in the art could choose fields existing in the X.509 standard such as common ones like organization, sub-organization, and common name.

In one implementation, the unique information in a certificate can be a field containing a specific unique numeric value. In this case all Ux are defined via the certificate as an abstract number.

In one implementation, Ux can request certification from each Mx in G using ALGO1.

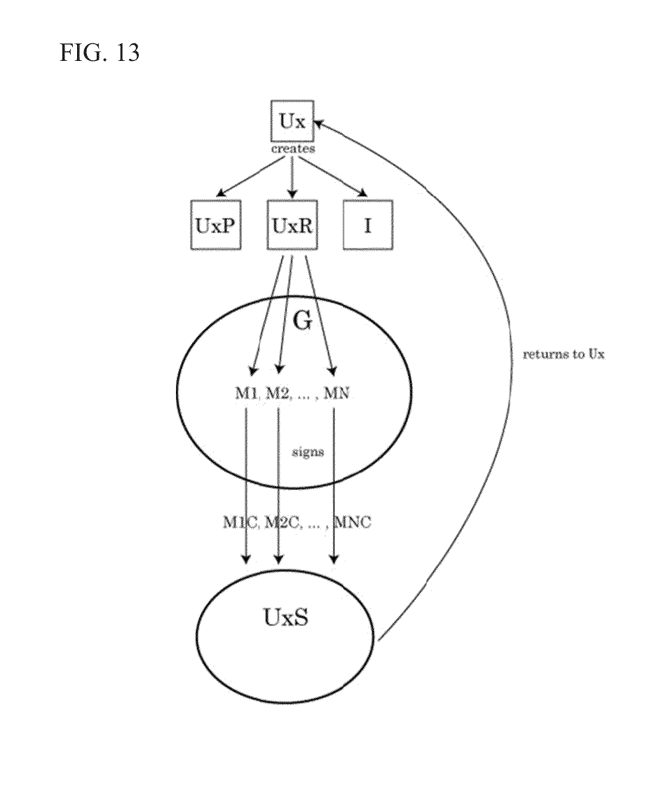

Another process, referred to as ALGO1, is now described with reference to FIG. 13. In this implementation, ALGO1 includes:

1. Ux creates UxPPK

2. Ux creates a certificate request UxR that contains the public key in UxPPK, and some unique identifier I for Ux.

3. Each Mx in G performs the following actions when receiving UxR:
a) Mx validates that it has not created any certificate containing the unique identifier in UxR. If it has then run step 3 for the next Mx and return no certificate to the user.
b) Mx creates and signs a new certificate UxC that contains the unique identifier and public portion of UxPPK and returns this certificate to Ux.

Ux now has a set UxS of certificates comprised UxC created by all Mx, where each certificate is signed by a unique Mx. UxS contains N certificates, assuming no exit of step 4 of ALGO1.

Group G can be used as a replacement for a CA in traditional PKI systems.

Ux can contact any user of PK and authenticate using the private portion of UxPPK. Define X as a party contacted by Ux that would like to authenticate Ux against PK, where PK uses G as a GA. Define UxA as the signed authentication method send by Ux to X. Typically X would send a random value to Ux, and Ux would respond with signed message UxM, where UxM was signed by the private key of Ux.

Another process, referred to as ALGO2, is now described. In this implementation, ALGO2 includes:

1. X requests UxS

2. X validates that UxM contains the proper signature and information. If not the authentication fails.

3. For each UxC in UxS, X verifies that UxC was signed by a member of G and declares that UxC valid. X may optionally check other types of validity as well, such as valid-from date and valid-until dates, as an example.

4. X creates sum S containing the number of all valid UxC certificates

5. If S is greater than (N/2)+1, where N is the number of nodes in G, then X has authenticated Ux.

Assume that some number J nodes in G have been captured by an attacker. This implies that J Mx signatures cannot be trusted. However, so long as J is less that N/2, the system is safe. If the attacker creates UxS with spoofed certificates, UxS will contain only J certificates. This prevents the attacker from gaining the majority needed to pass authentication at step 5 of ALGO2.

In one implementation, X additionally validates that each Mx signing UxC has valid cross-signatures by a majority of other Mx in G. If not, any UxC signed by that Mx are considered invalid. Further, future iterations of ALGO2 by X may use this information to discount Mx entirely. In the case where an Mx was discounted, the total number of nodes in G, according to X, would be N−1.

Define a concept Trust Level which means the percentage of authenticating nodes in G that successfully validate and authenticate X. This is the value (S*2)/N. If the Trust Level is greater than 100% than the system is secure and we can define such a transaction as fully trusted. It should be noted that any level greater than 100% has no additional value. Thus a fully authenticated check against all Mx in G producing a Trust Level of 200% has intrinsically no more value than a trust level that is greater than 100%.

If a tie-breaker node was used, and the tie-breaker node properly authenticated, and S=N/2, then add 1 to S to give the trust level a clear majority.

Fundamentally any entity gathering control of more than (N/2)+1 Mx controls the system. That entity could modify G such that any Mx not controlled by that entity would have its cross-signatures invalidated by the majority of Mx. In this case N would be the number of Mx with proper cross-signatures, which would be only the Mx controlled by the entity. Therefore a trust value of greater than 100% represents full trust.

In one implementation, certain types of operations by X can be limited by the trust level. For instance a trust level of 20% may allow read only informational access to low-security data, a level of 50% may allow non-critical interaction such as sending messages or allowing email to be checked, and a level of 100% or more would be used for critical transactions, such as monetary transfers, PK policy changes, etc.

In one implementation where each Mx certificate is signed by a CA, then X can additionally validate that each UxC signed by an Mx was correctly signed by that CA. If not, than that UxC would be declared invalid.

In one implementation, X maintains a subset of G internally in a set called T, and validates against T instead of G. T may contain N−1 or fewer nodes of G.

In one implementation, X validates only a single UxC against a valid Mx. If UxC is valid then X has authenticated Ux. In this case the Trust Level of X is 2/N. For example, if N was 3, the Trust Level would be 66%. This mode of operation is not recommended as it allows any attacker to validate against X after capturing only a single Mx in G. However, it is worth noting that this mode of operation is identical in security to the state-of-the-art existing mechanisms in all web browsers for authenticating TLS/SSL connections for financial transactions, critical data exchange, and command and control.

ENT may implement a Group Authority structure. This GA consists of a group of servers in different locations running different Asymmetric key process. Each such server is referred to as a root. Each root signs and operates independently of all other roots. Each root has a unique name defined as a set of consecutive characters. Together, using the processes found in Group Command and Control and Group Authority sections, the roots are able to issue new verinyms. The preferred implementation is to create a GA with an odd number of nodes to avoid deadlock. In ENT, the set of signed and self-signed certificates for all roots that create a majority as calculated in AlGO1 in Group Command and control is referred to as the root-ring. In one implementation these certificates can be combined synchronously into a single document per the Group Command and Control section.

ENT roots may be revoked. This may occur for any reason that would reduce the security or trust of the ENT system. Some potential causes would be faulty computer hardware, malicious attack, audit failure, natural disaster, planned root senescence, etc. A root is revoked via the mechanism outlined in the Group Command and Control section. If a root should be revoked, each other root server in the root-ring will create an revocation certificate targeting the root to be revoked. When a majority number of such certificates have been issued by unique roots, the root in question will be removed from the connected graph of root nodes as per the mechanism outlined in Group Command and Control. Any users of the ENT system who receive these certificates will likewise remove the revoked root node from their trust stores (T).

In one implementation, a root node can invalidate itself. In this case the system will treat the invalidation as an equivalent to a majority number of invalidation certificates by other roots. That is, a root invalidating itself must be treated as though a majority number of other roots produced invalidation certificates for the root. According to various implementations, it is recommended that both mechanisms be used.

ENT roots may also be added. This occurs when the system needs to grow or when revoked roots need to be replaced. ENT uses the mechanism for adding nodes found in Group Command and Control to accomplish this task. First the PPK for each new root is created. Then the public key portion is sent to each root in the root-ring. Each of the root-ring roots will then create a cross-signature for this new root containing the new root's public key. These certificates are then added to each root's trust store (T) via the mechanism outlined in ALGO2 of the Group Command and Control section.

### ENT System State and Trust Stores

ENT root trust stores are ideally stored on every ENT enabled system (running ENT software) in the entire ENT network. These devices can be called ENT nodes. It is valuable for all users of the ENT system to maintain separate trust stores (T). This allows partially or sporadically connected ENT devices to usefully maintain operation even if the roots or other parts of the ENT system are unreachable. Additionally, an attacker would need to defeat a large number of nodes in the system to damage the effectiveness of the system as a whole. As root node invalidation and new ENT root nodes are processed, these certificates can be propagated between ENT nodes until the entire ENT system has the updated, identical state since ALGO1 (or ALGO101) of Group Command and Control is deterministic and idempotent.

In one implementation, ENT nodes' trust stores can be synched each time they communicate or exchange information. In one implementation nodes exchange all certificates in the trust store T before transacting. This may be less preferred because this can be a very large amount of data.

In one implementation, a cryptographic hash is produced from the roots' self-signed certificates. These certificates are first ordered. Any deterministic ordering will suffice. In the preferred implementation the ordering consists of standard alphabetical ordering of the root name. Once the ordered list of root self-signed certificates is created, the hash is computed by inserting each such certificate, in order, through the hashing function which produces a numeric hash. Each ENT node will independently create this hash and store the resultant value.

In one implementation, when two ENT nodes communicate or exchange information they will exchange this hash first. A mismatch of this hash will force the two ENT nodes to exchange their trust stores (T). As shown in ALGO1 (ALGO101) of Group Command and Control, a trust store is recalculated after all nodes have been exchanged. After one iteration of ALGO1 (ALGO101) both ENT nodes will have identical trust stores and therefore identical hash values.

In one implementation, an alphabetical ordering of the root certificates is performed, as above. Each certificate is then hashed. The hash of each such certificate is then added to a data object, in order. In practice, the hash values would be concatenated together, in order, to produce a value ENTSTATE. Additionally, a value determining the ENT system version would be concatenated onto ENTSTATE. The ENT system version may contain information such as the constants used by the system, allowed process, etc. Once calculated, ENTSTATE reflects an object or datum containing all roots, individually recognizable (by their location offset in ENTSTATE), as well as a system context value that could be used for compatibility checking between nodes. This ENTSTATE can then be exchanged between nodes. The hash of the ENTSTATE can be exchanged first. If this does not match, then the full trust store, or portions thereof (as determined by the root hashes in ENTSTATE) can be exchanged until both trust stores match.

In one implementation, ENT nodes may check directly with any roots to receive a full trust store in addition to being able to receive this information from other ENT nodes.

In one implementation, the system version can be defined by a number of values and settings. Some settings include the cryptographic process used, hard-coded values such as minimum key lengths, policy settings such as the certificate naming structures and formats, etc. In the preferred implementation, all of these values are determined by a single version value, which may be used as the system version.

In one implementation, ENT nodes may not interact if their trust store hashes or system version values differ. ENT nodes must have consensus in their trust stores and system version before transacting. In the case of a mismatch on the system version the nodes should terminate their connection and the node with the lower system version should update its software. In the case of a trust store mismatch, both nodes should exchange certificates until consensus is reached at which time they can continue any transactions. If consensus cannot be reached, the transaction should be terminated.

### Verinym Issuance by Root Nodes

In ENT, verinyms can be identified uniquely based on a unique number or mapping thereof, and are issued by the first root to receive a request. In other PM systems a name or descriptive section is used for the issued certificate. Typical values are name, organization, organizational unit, etc. However, in the preferred implementation, ENT operates by issuing abstract identifiers directly as numbers. Each number is unique and guaranteed to be unique within the system as mentioned in the Group Authority section. No two roots may issue the same identifier to two different requestors. Other implementations might use alphanumeric numbers, or allow the requestor to choose a given identifier value.

Verinyms can be defined as a set of certificates, each issued by a unique root node. Each such certificate contains the public key submitted by the requestor, and a unique number within the system. Therefore a full verinym would contain N/2+1 or more certificates where N is the number of root nodes in ENT each containing the unique identifier for that verinym. Various places in this document refer to verinym credentials. This term refers to the certificates found in a verinym. Verinym and verinym credentials are interchangeable if the context refers to cryptographic primitives or credentials. In some implementations, a single document can contain the same information as a number of certificates, as per the Group Command and Control section.

The issuance of a verinym starts with a requestor (user requesting a verinym) creating a PPK and submitting a request to any one of the core roots. The request contains the public key of the PPK pair. In one implementation, the request may also contain a list of peer nodes that will be discussed later.

In one implementation each root has a predetermined block of numeric values that it assigns to requestors. For instance, root 1 may have block values 1-1000, root 2 would have block values 1001-2000, etc. In one typical implementation, these block ranges could be 32 bit blocks. Only the root granted permission to a block may assign numbers in the given block. Assignment of a number in another roots block should be treated as a security breach. The central office of ENT dictates which roots can issue which blocks. In the preferred implementation, a root that has issued all of its block should be invalidated and replaced with a new root with issuance control over a new block. In another implementation, a root that has issued all of its block can be assigned a new block by the central office. In the preferred implementation, a root will issue to a requestor a sequential number chosen within its valid block that has not been issued before. In another implementation the root could issue a random number from its valid block.

Once a root has chosen a numeric value NV from its block that has not yet been assigned, it creates and signs a certificate containing the requestor's public key and NV. This certificate is then forwarded to each other valid root in the ENT system. Each of these other root nodes first validate that they have not already issued a certificate containing NV, then create and sign a certificate containing the same requestor public key and NV. This set of certificates is then returned to the requestor as a complete verinym. In practice, the requestor will likely check a data store into which the roots will deposit newly created certificates. The requestor now has a valid verinym for whatever purpose they require.

Once issued, it is possible that private key for a verinym may be lost, stolen or invalidated. At some point the private key will need to be replaced for a given verinym. When these events occur it is important to provide a mechanism for the verinym owner to reestablish control of the verinym since control is lost when the controlling private key is lost. In traditional PKI systems this would require involvement of some personnel to reestablish the identity of the user in question. In ENT, the process is automated using a novel technology called Relational Authorization that is applicable to any PM system.

### Relational Authorization:

The following section describes a way to reestablish control (through replacement) of PKI credentials when a user loses control of their credentials or private key in a PM system, or to authorize action of a credential based on relational use of other credentials. These can be thought of as an ownership policy, and one or more control policies, respectively. The high level concept, dubbed Relational Authorization is to allow an entity, based on a peer group they define, to request of those peers endorsements or vouchers that can be used with the Certificate Authority or Group Authority to reestablish ownership and create new signed credentials for the entity. Additionally, the same concept allows a set of peer entities with their own credentials to vouch an action (or control mechanism) for the entity.

First, note that Relational Authorization requires no specific characteristics to be present in peers beyond those required by the entity itself. That is, it's anonymous and private. Secondly, the CA no longer needs to perform renewals based on the current state-of-the-art mechanism, which is always a centralized approach. Finally, note throughout that no claims are placed on the CA for manpower, management, or procedure, and that, in fact, the CA needs to manage no user/entity information at all beyond the abstract identifier.

While most of this section will concentrate specifically on use of Relational Authorization for renewal of credentials, the invention outlined has much broader applicability when authorized action is desired and multiple credentials are desired as inputs to that authorization. For instance, Relational Authorization can replace a public key in a credential with a policy that consists of multiple entities working in concert to prove control of an identity for authenticity, to allow an identity access to data, or for any purpose whatsoever.

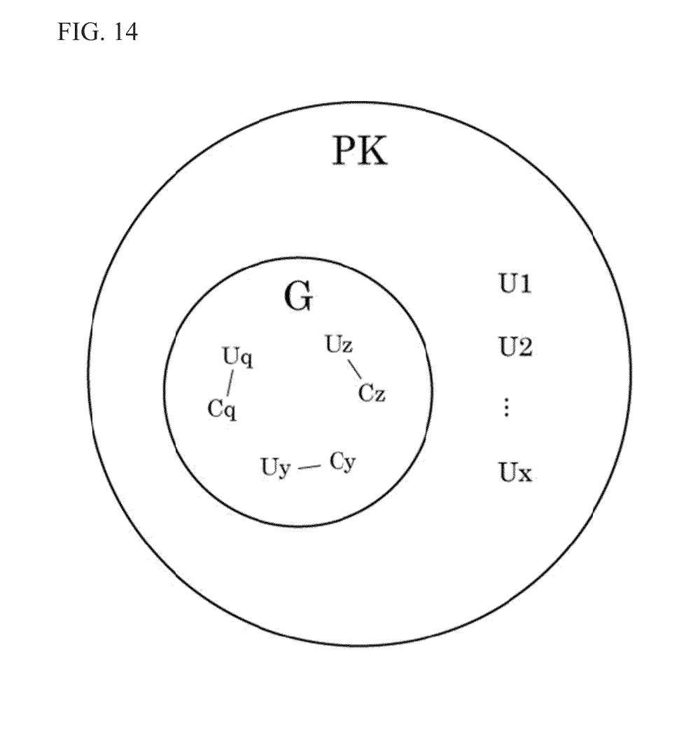

Define a PKI system PK consisting of a group of N entities/users. Users may be people, computers, mobile devices, or other electronically enabled systems that allow credentials to be stored and used. Define the CA as the certificate authority of PK. The CA may be a Group Authority (GA). Define each entity as U1 through UN and their credentials, signed by the CA, as C1 through CN, where U5 represents user 5 and C5 represents user 5's credentials. Define each entity's private key as P1 through PN, where P5 was entity 5's private key, and define Pm as an arbitrary entity's private key. Define Ux as an entity that needs to replace Cx with a new certificate Cx′. Define a group G with a number of M entities where each entity is in PK and has a real-world or out-of-band relationship with Ux. Define an arbitrary one of those entities as Um. Define the credentials for Um as Cm. For example we could define a G with 3 entities Uq, Uz, Uy, each controlling Cq, Cz, and Cy respectively. See FIG. 14.

In one implementation, define a data object L containing G and a policy statement S. S is a policy statement consisting of a set of processic rules for combining members of G into a statement that provides a Boolean value as output. For instance, S could contain a consecutive list of characters “(Uy and Uq) or (Uz and Uy)”. Additional non-Boolean rules could be created such as “majority(Uy,Uq,Uz)” or “2 of (Ua,Uy,Uq,Uz)”. S defines the criteria by which the CA should allow a rekey for Ux. Useful rules would contain basic Boolean operators (OR, AND, NOT), ordering for grouping statements, and functions. Any number of different functions could be supported, but a function must return a value that indicates true or false and must take as input one or more members of G. The syntax of S depends largely on credential format and specific implementation, but could consist of XML, JSON, string, or other binary formats. These statements can evaluate to true or false if an arbitrary Um in the statement is replaced with a “true” value. By default all such values are considered false. In short, Um values are replaced via ALGOY by “true” values if Um signed a voucher authorizing the action, or if Cm contained a policy Sm that itself evaluated to true.

In another implementation, grouping of operators in S can have a precedence value. This value can set a priority on the inputs. For instance, “(Ux and Uy,101)” could represent that the statement has priority 101. In one implementation, higher priority statements that evaluate to true override lower priority statements that evaluate to true. Priorities are useful if an attacker gains some number of Um entities were compromised by the attacker, and the attacker can spoof a true value via S. In this case it would be beneficial for the CA to prioritize a more secure set of Um entities over the valid, but spoofed entities the attacker has control of. This allows the algebra of S to contain a hierarchy of control even within the policy. In this case the CA would remember the priority value of the last authorized action. If a more high priority action occurs later, the CA can allow the new interaction and revoke the previous.

In some implementations, a higher priority credential reset could disable lower priority resets for some specified period of time. For example, two weeks. This would disallow an attacker from resetting the policy again for that duration of time and disable flip-flopping contention between different authorizing groups in the policy.

In another implementation, data object L does not need to contain G, since this information is also present in S.

In a typical implementation, authentication is typically done directly with a private key. However, using Relational Authorization a credential can instead be authenticated against a group of peers via S. That is, S can replace a public key in a credential. For example, if a credential represented organization, and that organization needed secret data access, and three individuals were needed to authorize that access, Relational Authorization could be used to satisfy that authentication process instead of the organization needing a specific PPK. A person's credentials, as an example, might be required to use both their smart phone and a key-fob device to access their bank account. Both their phone and their key contain private keys, and in concert allow the individual to gain access to their bank account via S in their credentials. In this case, the credential contains a policy for authentication instead of a public key. The public keys are held by the actors in the policy S. To clarify, Pm is replaced with a policy statement S which contains actor X whose own Px may be a private key or may be another policy statement Sx. In such cases it is vital that nested Sx statements do not form loops. For instance, if U1 had S1 consisting of “U2”, and U2 had S2 consisting of “U1”, then neither statement could ever evaluate to true, because neither statement has input from a PPK that could set a portion of statement Sm to true. In some implementations, this looping can be limited using a depth criteria, such that only a certain integer number of recursions is allowed before the process exits and a return value of false is returned. In some implementations, a policy S may only be legal if at least one path returns a true value.

While covered in other literature discussing tokenizers, it is worth noting that a statement S containing a U1 that is controlled via statement S′, that S can be expanded by replacing U1 with S′, wherever U1 appears in S. For instance if S was “U1 and U2”, and S′ existed for U1 and consisted of “U4 and U5” that S could replace “U1” with S′, yielding “U4 and U5 and U2”.

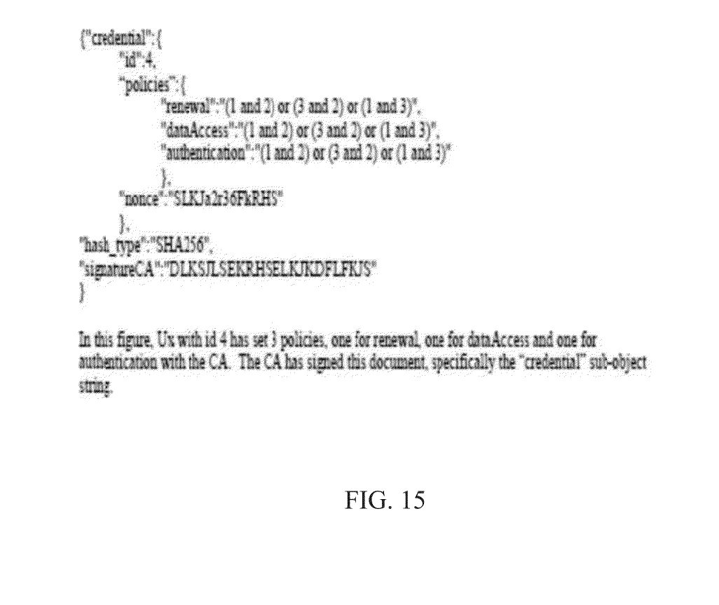

Multiple policies may exist in a single L, each dealing with specific action or authority in the system. For instance, access, authentication, renewal, etc. In some implementations, any number of such policies can be created, distributed, and managed by the user in the same way that an ownership policy can be created and managed with the CA. See FIG. 15 for an example credential in JSON format. In certain implementations, these policy statements may exist in credentials issued by the CA. In other implementations, these policy statements may exist in their own signed and authentic messages, also signed by the CA.

In a typical implementation, policies will exist in a credential that is replaceable via ALGOY, as in FIG. 15. That is, these policies (as a group) are replaced via a single credential renewal process. Some implementations may wish to separate renewal of these separate policies individually. In such cases ALGOY would exist and be executed for each such policy declaration. This mechanism provides a much more distributed concept of “identity” than typically comes to mind, and may have substantial secondary effects including management cost increases, complexity increases, etc.

In one implementation, the CA will provide temporary credentials to any requesting entity that submits a public key. These credentials will contain a simple increasing numeric value that is never repeated. Such certificates issued will differ from each other in their identifying metrics only based on this number and the associated public key. Further, these credentials will be clearly marked in the system such that they cannot be used for other purposes. Any user can request such a certificate at any time. For example, some user could request such a certificate containing a serial 1000. The next user requesting such a certificate would receive certificate 1001, etc. The same entity can request any number of such certificates. One variation of this is to allow such certificates to contain entity information. This information would match the identity of Ux if Ux was the requestor. This certificate must NOT be used in any form to identify Ux. Its purpose is only to establish a relationship between an arbitrary serial number and a public key in a secure and addressable manner.

Assume Ux creates a new PPK key Px′ and requests a unique certificate containing Px′ (public portion) using the above mechanism. Call this temporary certificate Tx. Ux now has a certificate that is recognized in PK, and presents a mechanism by which other users can validate the uniqueness of Tx using its serial number. Further, Tx can now be used by Ux in a temporary capacity to authenticate with other members of PK not as Ux, but as unique entity within PK. The uniqueness is defined by the unique serial number.

In one implementation where Ux and Um are people, Ux contacts Um in the real-world and requests that they submit to CA a rekey request for Ux. In the preferred implementation, Ux would communicate the serial number verbally to Um. Other methods of communication could include the telephone, verbal face-to-face, or via a video with sound. The important criteria is that Ux communicates the need for a new key, the serial number in Tx, and that Ux provides a strong proof of identity to Um. Proof of identity in this context means that Um recognizes Ux as the rightful owner of Cx, that Ux is a person, and the Ux is the person that Um thinks is the rightful owner. The best solution would be a physical meeting of Ux and Um, second best would be a video, third best would be telephone, etc. The stronger the proof of ownership and identity the better. Alternate or supporting mechanisms could include DNA samples, fingerprints, or biometrics of some type. The specific use and procedure of these are not in the scope of this document. The intent, however, is that Um is able to recognize Ux and determine that they are not an attacker trying to gain control of Cx or Cx′ by spoofing the real world identity of Ux. Entities other than people would use a different set of proof-of-identity identification criteria beyond the scope of this document but these could consist of shared secrets, physical access to computing devices, etc.

In one implementation, Um creates a signed renewal message RCx for Ux that contains the information in Cx, excluding the public key, and the unique serial number found in Tx. Um sends this message to the CA.

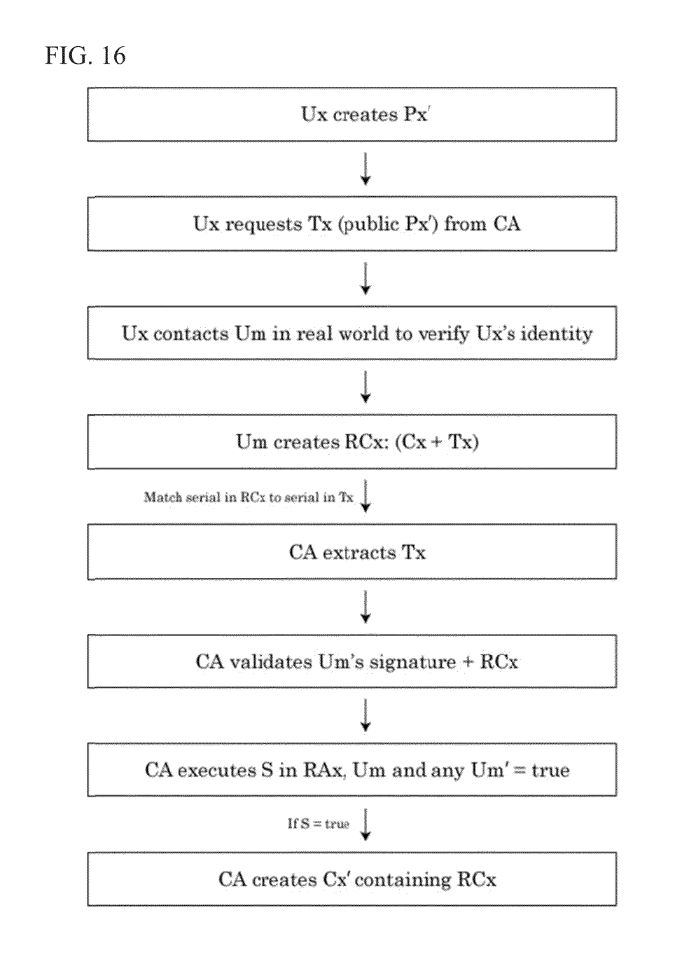

In a simplistic implementation, the CA will create Cx′ if any Um vouches that Ux controls the public key found in Tx. Upon receipt of RCx, the CA should validate that the information in Cx′ matches the information in Cx, and create Cx′. These steps, laid out more formally are as follows, with reference to ALGOX of FIG. 16:

1. Ux creates PPK Px′ (or policy Ax)

2. Ux requests certificate Tx from the CA where Tx contains the public portion of Px′ (or Ax′)

3. Ux contacts Um who performs some real-world verification of Ux's identity

4. Um creates a signed message RCx containing the user identity information in Cx and the serial number of Tx

5. The CA extracts the public key in Tx by matching the serial number in RCx to the serial number in Tx

6. The CA validates Um's signature and validates the identity information in RCx, and then creates Cx′ containing the public key from Tx and the user information in RCx

The simplistic mechanism for creating Cx′ in step 6 is not recommended in many instances. It is clear that an attacker gaining control of a Um in PK would allow that attacker to compromise any other Cx in the system. A more robust mechanism follows. Also note that Tx is not necessary for the creation of Cx′. It is merely useful. Each Um could instead submit to the CA a renewal certificate containing Ux's identifying information, and the public portion of Px′. The public key would be given to Um during the validation procedure between Ux and Um. Tx simply provides a more automatic, human-friendly way for the public key portion to reach the CA.

Define a message RAx, signed by Ux when Ux controlled Cx, which contains L and the identifying information of Ux. It is vital that Ux created this message shortly after Ux was issued Cx in PK and before Ux lost control of Px. If Ux lost control of Px before RAx was created, this entire renewal strategy fails. In one implementation, Ux created RAx as part of the original procedure of creating Cx. That is, Cx and RAx were created in tandem. This eliminates any time period during which RAx would not exist. This prevents an attacker from permanently destroying Ux's capacity to renew and replace Cx.

Ux submits RAx to the CA. The CA validates the message by checking that RAx was signed by Px, and that Px corresponds to Cx, which was signed by the CA. The CA then stores RAx indefinitely. This message will define the rules under which members of PK can request the creation of replacement certificate Cx′ for user Ux.

Ux now contacts each Um and requests that they submit a rekey request to the CA using the approach outlined earlier. Each such Um submits a signed message RCx identifying information for Ux, the public key corresponding to Px′. Ux may need to contact less than M Um users if the rules in S dictate that less users are required to produce a Boolean output value of true.

The CA receives some number of RCx messages from different Um users in G. The CA validates that each signed message originated from a Um in PK with a valid certificate Cm that was signed by the CA. The CA also validates that each RCx contains the an identical public key. If not, the CA should calculate of all RCx received, which public key matches in the most RCx. RCx with non-matches should be discarded.

It is possible that multiple valid RCx messages exist from a single peer x that contain valid key information for Ux. For instance, a peer could issue two vouchers, each containing a different public key as the target of renewal if Ux sent a renewal voucher request to the peer twice, with two differing keys. The CA has no way of determining which of these it should use. In this case, the CA collates all incoming vouchers from all peers into sets by unique public key for Ux. If there were more than one public key in the set of all RCx messages, the CA would create a set for each. The CA then processes each such set. The first set that passes the criteria in the OWNERSHIP POLICY determines the new public key for Ux. In some cases, where there is not an entity public key used for authentication, but instead a authentication policy

The CA then loads and executes the S in L for Ux, computing the output value. The output value is computed by inserting a true value for each Um in the statement S. For instance, if S was “(Uy and Uq)” and the CA had received a valid RCy from Uy, but had received nothing from Uq, then S would be calculated as “(true and false)” which would have an output value of false. If the result of the calculation is false, then the CA does nothing. If the CA calculates a value of true, then the CA has validated that the criteria written for S was met correctly. If so, the CA creates Cx′ for Ux, and the renewal is a success. These steps, laid out formally are as follows, referred to as ALGOY:

1. When Ux originally gained credentials Cx in PK, Ux subsequently submitted to the CA a signed message RAx containing data object L. The signature must either be the signature of Ux, or if Cx contains a policy S instead of a key, enough signatures of authorizing actors in S to authorize RAx.

2. The CA validated the signature and validity of RAx. If valid the CA stored RAx indefinitely

3. Later, Ux loses control of Cx (or policy Ax)

4. Ux creates new PPK Px′ (or policy Ax∝)

5. Ux requests certificate Tx from the CA where Tx contains the public portion of Px′

6. Ux contacts a unique Um who performs some real-world verification of Ux's identity

7. Um creates a signed message RCx containing the user identity information in Cx (Ax) and the serial number of Tx

8. The CA extracts the public key in Tx by matching the serial number in RCx to the serial number in Tx

9. The CA validates Um's signature and validates the identity information in RCx.

10. The CA then executes S in RAx, replacing each instance of Um with “true” so long as a Um signed or had a policy Cm (Am) that evaluated to true. For every unique Um in G that signed an RAx, or had a policy Cm (Am) that evaluated to true, repeat this step. Note that policy evaluation is possibly recursive.

11. If S evaluates to true, the CA then creates Cx′ which contains the same information as Cx but instead has the updated public key found in Tx.

12. The CA then invalidates the previous Cx (Ax) for Ux and publishes the new Cx′ (Ax′). This may take place using a CRL, or preferably, the unique revocation process outlined in Novel Key Revocation. Note that in that case, each RCx message MUST contain the public key found in Cx (or policy information in Ax). Otherwise the CA will not know which Cx a given RCx message was meant to replace. If not present, this would allow an attacker to execute a replay attack.

It is important that Ux be able to update RAx in the case where G changes. It is possible that certain users are no longer in PK, that new members should be added to G, etc. Thus RAx should be replaceable. However, Ux cannot replace RAx securely. Imagine that Px was compromised by an attacker. If Ux could update RAx then so could the attacker. The attacker could replace RAx with an RAx beneficial to the attacker. Then if Ux realized that they no longer had control of Px, they would have no recourse because RAx would no longer contain a group of trust for Ux, but instead whatever the attacker placed in RAx. Therefore replacement of RAx should use another mechanism.

Instead, RAx should be replaceable in the same way that Cx′ or Ax′ is created. Ux adds a new L′ of their choosing to Tx. Each Um then creates a signed message containing the serial for Tx and sends this to the CA. The CA then validates each message using ALGOY step 10, and calculates the same result of S. If true, the CA replaces RAx with RAx′, which contains L′, in step 11. The CA then stops using RAx and uses RAx′ for all future renewals. This procedure is identical to that found in ALGOY, except that in step 11, the CA replaces RAx with RAx′ containing L′, and Tx contains L′.

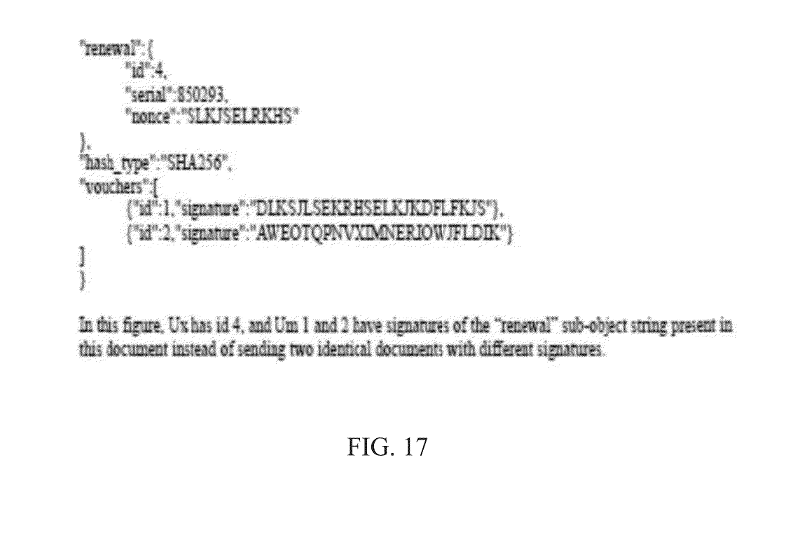

In one implementation, it is possible to combine multiple RCx messages into a single message that is sent to the CA. Since the key information in an RCx message is the user identification information and serial number, this information can be added to a single document, which is signed by one or more Um members. The document with multiple signatures can then be submitted to the CA instead of multiple individual RCx messages. See FIG. 17.

In some implementations, RAx′ replacement (step 12 of modified ALGOY) can be placed in an escrow for some predetermined period of time. This prevents an attacker from gaining control of authorizing nodes in S and resetting the credential before the credential owner has time to react. In this case, the CA does not immediately perform step 12 or release RAx′ publicly. Instead, the CA stores RAx′ for some predetermined period of time. In some implementations, this time period is set by the credential owner by adding a time period to data object L. In some implementations, the time period is fixed system wide. During this time the CA may contact each authorizing entity in S and Ux and notifies those entities that a credential reset is pending. Alternately the CA can post a public signed messages stating that the credential has a reset pending, and allow Ux and other authorizing entities to check that public location periodically. This procedure forces an attacker to capture and hold a number of credentials for an extended period of time while simultaneously notifying the various authorizing entities that a reset is pending. If those entities each themselves use Relational Authorization as their renewal mechanism for their individual Cx credentials, and each had a separate RAx renewal credential with other authorizing entities, it would be very unlikely for an attacker to take over and hold a large number of credentials without entity Cx′ renewals for the required period of time.

One can now perform a security comparison to calculate how much more secure such a setup is than existing PM renewal procedures. In existing state of the art implementations there is always a single point of failure. Either the Security Officer or group in charge of the process of renewal creates a signing request respected by the CA. This is then applied. However, if the Security Officer or group's signature key is compromised by an attacker, that attacker gains access to future creation of new user certificates until that key can be revoked.

While it is unlikely that a single person would have the same security context or security training as a procedural group or officer, we can also see that via a permutation calculation that it is not difficult to surpass the security of a group or officer using a multiplicity of less secure keys acting in concert. For instance, inclusion of just 2 additional RCx signatures from two unique Um entities in addition to the signature of a Security Officer has a dramatic effect. If each Um's credentials had a tremendously elevated 50% chance of compromise during the lifespan of Cm, the total security has still been increased to 400% of the Security Officer's key alone. In fact, each additional user added “anded” to this list (using Boolean operations in S) increases the security further by a factor of 200%. This is an exponential function in which the chance of compromise collapses by ½ for each additional user. Clearly this approach is more secure than any state-of-the-art rekey procedure. Further, the Relational Authorization principal can be applied for any set of control characteristics desired yielding the same levels of increased security for authentication, data access, delegation, etc.

### Relational Authorization in ENT:

When a verinym's keys are invalidated or compromised, Relational Authorization can be used to reestablish control of the verinym. The owner of the verinym (Ux) creates a list of peer ENT users whom the owner trusts. These users then become a renewal peer group for that owner's verinym. When the owner loses control of the verinym the owner will contact enough of their peer group (G) to reestablish control of the verinym. The exact method for calculating which peers and which number of peers can reestablish control is left up to the owner of the verinym to define (via the statement S). This implies of course, that a user created a ownership policy earlier (RAx).

In one implementation, an owner can reestablish control of a verinym by first creating a new ENT verinym from scratch (the equivalent of creating Tx). Once this new verinym is created it can be used for secure transfer and authentication with other ENT peers. This verinym can then be used to contact the renewal peers. Each peer can then (via voice or video chat) validate that the user is the correct owner of the verinym being renewed, and then vouch for that renewal by creating a signed endorsement (RCx). This endorsement can then be transferred to the roots, which will then reissue a set of certificates for the verinym in question. Note that each root performs ALGOY independently, and via the combinatorics found in Group Authority section, those Cx′ certificates become the new verinym credentials for Ux.

After a verinym is issued, verinym holders may submit to the roots a signed OWNERSHIP POLICY message (RAx above). A OWNERSHIP POLICY message is a signed message created by the verinym owner that contains a policy statement (the same as statement S above) and a list of peer renewal members (list in object L above) that would allow the verinym to legally be updated to include a new PPK.

A RENEWAL VOUCHER message (RCx message above) is a message signed by any member of the renewal peer group for a given verinym and submitted as an endorsement to a root server.

The policy message contains a Boolean expression that is executed each time a root receives a RENEWAL VOUCHER message that contains the target verinym id. If the Boolean expression is true, the root will issue a new certificate for that verinym wherein the public key is the key matching in all valid RENEWAL VOUCHER messages.

As per Relational Authorization, the Boolean expression in the OWNERSHIP POLICY contains variables, logical operators, and logic functions evaluating to a true or false value. The combination forms a Boolean statement. Each variable is a verinym id. For each signed, authentic RENEWAL VOUCHER message received, the appropriate verinym id will be replaced with a true value. If the Boolean expression evaluates to true without any RENEWAL VOUCHERS existing, the policy is considered invalid and is not kept. If the Boolean expression contains the verinym id to which the OWNERSHIP POLICY applies, the policy is considered invalid and is not kept.

The OWNERSHIP POLICY message contains a Boolean statement and a list of peer verinyms. This list of peer verinym ids must consist of the verinym ids found as variables in the Boolean expression. The first valid policy sent to a root is the only such OWNERSHIP POLICY kept. Any subsequent policy messages are discarded (unless they are accompanied by enough vouchers to establish a new policy as described below). Therefore it is important that a OWNERSHIP POLICY be sent to the server as expediently as possible after the verinym certificate has been issued. If an attacker were able to briefly highjack the private key of the user, and a OWNERSHIP POLICY message had not been sent, the highjacking would be permanent and irreversible. If the verinym holder does not want a peer enabled OWNERSHIP POLICY the verinym holder should submit to the Trunk a OWNERSHIP POLICY wherein the Boolean statement always evaluates to false.

To change an existing policy, the following criteria must be met.

1. Peer verinyms found in the peer list of the existing OWNERSHIP POLICY may submit valid OWNERSHIP POLICY messages, wherein the Boolean expression and the verinym ids list matches across all such messages; and

2. The current OWNERSHIP POLICY Boolean statement must be satisfied when substituting verinym id variables in the Boolean statement with true. That is, each verinym id in the existing OWNERSHIP POLICY Boolean statement is replaced with a true value if an authentic OWNERSHIP POLICY message has been received from the matching verinym id, and the Boolean statement then evaluates to true.

Satisfying these criteria establishes that the peer group authorized to renew for the target verinym has also authorized the change of the policy. It also establishes that the new Boolean statement is exactly agreed upon by all involved peers. At this point the existing policy is replaced with the new policy.

In some implementations, improvements can be made to prevent information leakage. Information leakage can occur in that verinym renewal peers are visible to anyone examining a OWNERSHIP POLICY. Tracing subsequent relationships between verinyms can produce a connected graph used to infer connections between verinyms and simplify a real-world mapping to people or machines. An attacker with such information could theoretically plan a coordinated attack on a set of nodes that would allow them to gain permanent control of a verinym. Improvements to prevent this can be made but add complexity to the system.

In one implementation to limit information leakage, each OWNERSHIP POLICY (contents of L above) can be encrypted using the public key portion of each root's PPK to create an L′. Once encrypted, only the root server is capable of decrypting the encrypted contents of L. Any other external party cannot decrypt the contents of L. When a root receives a RENEWAL VOUCHER, that root can decrypt the contents of L′ to produce L, and then calculate a value for S as above.

In one implementation it is valuable for an external auditing facility A to be able to validate and audit a renewal process. This implies that A is able to calculate L′. An owner O of a verinym has L, since O originally calculated L before encrypting and sending to the roots. In one implementation O simply keeps L somewhere relatively private. In the preferred implementation, O can request L from the roots. In this case, the root contacted by O will decrypt L′ to L, encrypt L with O's private key to produce L″, and transmit this message to O. O can now use its private key to decrypt L″ and retrieve L. Once O has retrieved L through some mechanism, O can submit L to the A. A can now compute and validate L′ by encrypting L with a root's public key. This ensures that the root is using the same L that A has obtained.

In the above implementation A also needs access to all RENEWAL VOUCHERS submitted to a root in order to perform a full audit. A can retrieve these values from O. In the preferred implementation, A can retrieve the RENEWAL VOUCHERS from the root directly. In this implementation, the root renews a policy or verinym for O as before. Once the renewal is successful, the root then collates all RENEWAL VOUCHERS into a single object, and encrypts that object with L, producing RV. The root then makes RV public. Auditor A can now retrieve RV, and using L, retrieve all RENEWAL VOUCHERS used in a policy replacement or verinym key replacement. A can now perform a full audit to ensure that a root had permission to renew a verinym key or replace an existing ownership policy. A failure to perform an audit for O when requested may be escalated. A root may then be determined to be compromised if there is no correct audit information.

In one improvement, L may contain a random number or value that makes L very unique. For instance, adding a 128 bit random value to L. This prevents an attacker from guessing potential values for verinym ids in L and the format of S, and reconstructing L by trial and error.

In the preferred embodiment, when a new replacement set of credentials for a verinym is created, the existing credentials are invalidated. This is accomplished through a novel approach for Key Revocation that can be used in any existing PKI system and is described below. In short, the valid certificate signed by a given root that has the newest creation timestamp is considered to be the valid certificate. All other certificates with the same verinym id with an earlier dated timestamp are considered invalid.

### Novel Key Revocation

To explain the novel improvement it is necessary to provide appropriate context. Imagine that we have a certificate authority A, data storage (often called a directory) D, and user U. U is authorized to request a new certificate from A. U creates an asymmetric key K with private/public key-pair (px,py) respectively. U wishes to create a certificate C containing py, signed and authorized by A.

In one implementation U performs the following steps BEFORE requesting C.

In another more typical implementation U performs the following actions AFTER requesting C.

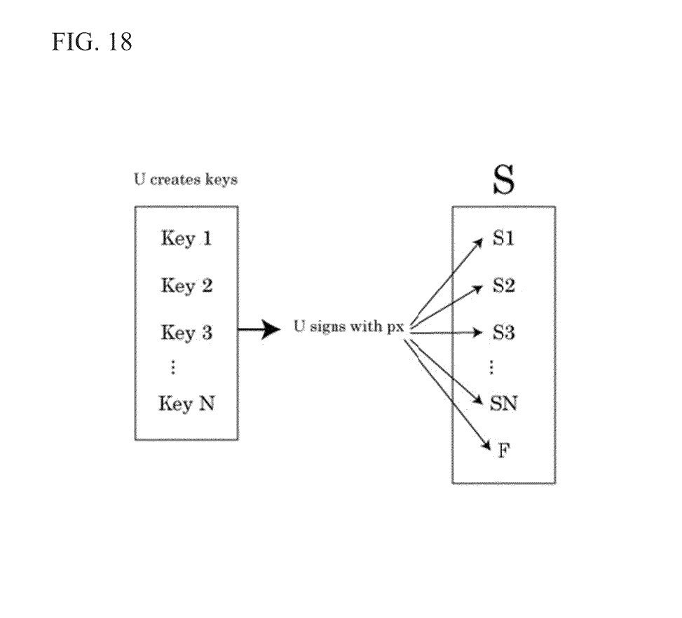

A procedure, ALGO1, is described with reference to FIG. 18:

1. U creates a set KEYS of asymmetric keys 1 to N, where n is an arbitrary number that matches the assumed lifespan of C before a certificate renewal is needed from A. Value n may be determined based on any time increment. For instance, if the time between certificate renewals was 1 year, and the increment was 1 day, then n=366. This would provide one certificate for each interval, which is for each day. Alternately N can be determined based on space, transmission, or other requirements, and the interval can be derived from the number N. Value N need not be larger than 1, in which case KEYS contains only 1 key-pair. U then creates set S containing certificates 1 to N, where key-pair KEYS[x] is used to create a certificate S[x], and each certificate is signed by C such that the certificate chain C->C′ is a valid certificate chain. Each certificate in S also contains a unique value in the certificate “serial” field. Typically this value would be values 1 to N, where certificate 1 in S would have serial value 1, certificate 2 would have serial value 2, and so on.

2. U signs each certificate in S with px.

3. In one implementation, U creates a final certificate F which contains a serial termination value of, for example, “N TERMINATE”. Alternate implementations would use a different certificate value, or a different text value for the serial value to contain some token that represents a termination of the certificate incrementation. That is, it terminates the set S such that anyone looking at all the certificates would be able to determine that there were no more certificates in S with value greater than N. In another implementation, F is NOT created, and each

4. After any requests to create C (if before) and all the above steps have been accomplished, U destroys key K containing px,py.

K is now unrecoverable. Unless an attacker had access to the machine on which these steps have been accomplished, the attacker cannot access K or create additional keys similar or symmetric to the keys in S. U now has a list of N certificates in S, numerically incremented, and a certificate F which contains information that clearly denotes the size of set S, and clearly denotes a termination. Further, U has not yet shared these certificates with any other party. They were created locally, and A was not involved.

Define a set CERT consisting of N objects, wherein each object contains pair (S[x],KEYS[x]) for each x between 1 and N.

In one implementation U now encrypts each object in CERT, and certificate F with a private key P, yielding set PS which is a set of encrypted objects of size N (each containing a certificate or a certificate/KEY[x] pair). P is a password known only to U.

In another implementation U splits each object in CERT into J parts, which it encrypts with J individual keys. These keys may be asymmetric or symmetric keys. If asymmetric keys, one implementation is to encrypt each part with the certificates of peer users. Call this peer group T. In such case, PS consists of a set of sets, each containing these encrypted objects, where each subset consists of J parts.

In one implementation U transfers PS to the directory for storage.

In one implementation U transfers PS to other peer users for storage.

In one implementation U stores PS offline on a disk drive or other storage medium such as a pen-drive.

In one implementation U breaks up each object P′ in PS into J parts, and places each such part in different locations. Locations may include the locations above such as peers, local storage, CA storage, etc.

Define certificate C′ (C prime) as any certificate in set S. The PKI system must treat any certificate C′ as having the validity of C. It can be validated that C′ maintains a correct certificate chain to A. A signed C, C signed C′. Therefore C′ has a direct path to A using PKI certificate chaining It is clear then that each C′ has been signed by C. Therefore other members of the PKI system can clearly trace C′ to A if they have a record of C, and allow trusted communication, authentication, authorization, etc. to occur within the system for U when U holds C′.

Each user (directory, individual, CA, third party, etc.) of the PM system must treat a certificate C′ containing a GREATER serial value as the valid certificate, and any existing certificates signed by C with LESSER serial values as revoked and invalid.

In one implementation that may include the above, each user that receives the final certificate F containing the termination value must no longer allow any transaction with C′.

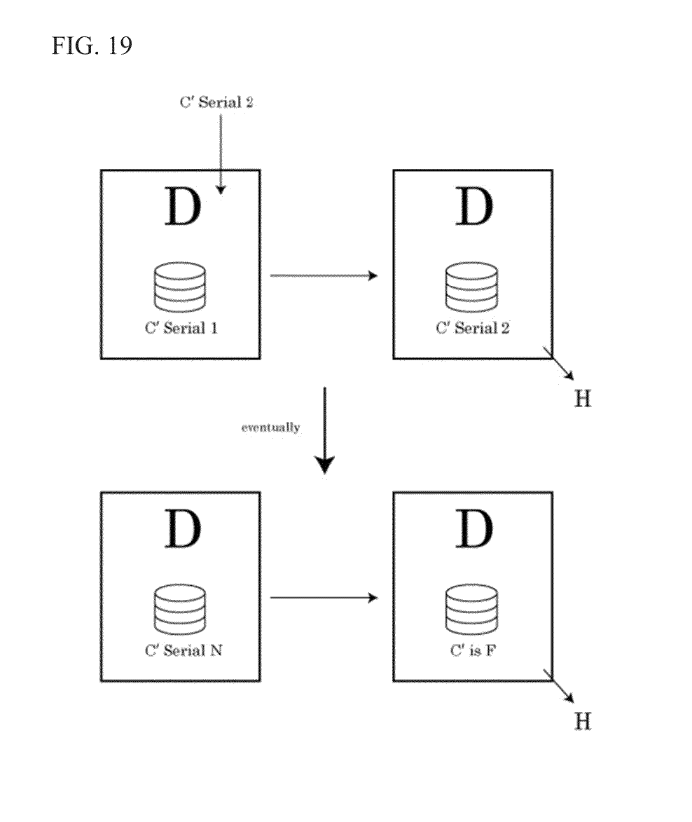

The following example demonstrates this concept, with reference to FIG. 19:

1. C′ with serial value 2 is submitted to directory D

2. D contains a C′ with serial value 1.

3. D discards C′ with serial value 1, and stores C′ with serial value 2.

4. User H requests certificate for U and receives C′ with serial value 2.

5. F is submitted to directory D

6. User H requests certificate for U and receives F. User H disallows transaction and any future transactions.

Therefore, the current most recent C′ in the PKI system at large is considered the valid C′ and all others with lower serial values are ignored and considered revoked. If any user of the system receives a larger value for the serial in a C′, then that C′ is used, any connections open to a lower serial C′ are closed and all services for those lower serial C′ certificates are disabled.

In one implementation, when a request or signed directive, or other business is conducted or initiated by any entity holding the private key portion a C′ with a user, that user queries multiple directories to check if a larger C′ exists. If so, that request or business is canceled, the entity disconnected, etc. That is, the holder of that lower valued C′ is not considered a valid owner. It can be shown that, in such an implementation, each additional directory added to the query increases the chance that a larger value C′ is found, assuming there is one in the entire world of directories comprising the PM.

U now has a list of certificates that they can use as replacements for C that function with the same cryptographic strength. U can use any C′ in their set so long as the rest of the PKI system has only seen that C′ and no C′ with a higher value.

Define C1,C2 . . . CN as the certificate values in CERT. Define K1, K2 . . . KN as the public/private pair of keys in CERT whereby K1 decrypts data encrypted using C1, K2 decrypts C2 encoded data, etc.

After A signs C and U performs ALGO1, then U can begin using C1 and K1. When C1 or K1 become lost, or stolen, or based on some period, U can then perform the following actions. To clarify, in one implementation U could rotate certificates daily, or based on any period. U gets the encrypted or split object containing C2 and K2. This object is encrypted in one implementation and U decrypts it with their private password. In another implementation U gathers all pieces P′ to reconstitute C2 and K2 from various locations, and then decrypts the contents (if they were decrypted). In another implementation U contacts peers T and has each member decrypt and present their portion to U until U can reconstitute C2 and K2.

U now has a valid C2 and K2. U distributes C2 to one or more directories. Each such directory replaces C1 with C2. All future users contacting each such directory will get C2 instead of C1, and will be able to verify that it is valid and that C1 is invalid. In one implementation, U also distributes C2 to a list of users that U interacts with or has interacted with. These users can cache C2, immediately disallowing an attacker from using C1. In one implementation, if users cache C2 they do not have to contact one or more directories to request the most recent certificate.

An attacker with C1 is now disallowed from accessing data and services for U once C2 is introduced into the system. C1 is revoked in practice, even though no explicit revocation process was performed. Instead, the promulgation of C2 invalidates and obviates the use of C1. This type of positive control is very powerful because it empowers U to manage their own certificate validity status and promulgate knowledge of the new certificate to users of the system who would benefit from knowing most.

Note that at no time was it necessary for U to request a certificate, Certificate Revocation List (CRL), or other data from A. All revocation has been handled by U and the various other parts of the system and ONLY when a transaction occurs. Further, no personnel were involved in any manual way except for U and any peer group they relied upon to reconstitute C2. For each future CX where X is 1 to n, U can perform the same operations. In one implementation, when or if U decides their certificates should no longer be used, or because C no longer contains a valid time stamp, U can release certificate F into the PKI system via directories or other means. In another implementation, instead of using step 2 from ALGO1, A signs each key instead of signing each key with px. A must sign the certificates but must not distribute or promulgate those certificates, beyond the first C1. In this case the certificate chain looks like A->C′. Otherwise the steps are the same.

### Traveling Keys:

Performing a key renewal using Relational Authorization requires communication with the central roots, involvement of peers, and some time and effort on the part of O. Additionally, each time a user must perform the renewal process the central roots must become involved, and this can generate extra load on the ENT central systems. It would be better if users had keys that were disposable. This would allow users to switch the device hosting their private key temporarily for various purposes, allow for cases where their devices were lost or stolen, etc. It would also allow users to switch keys more frequently without having to contact a root server. Ideally users should contact root servers as infrequently as possible. In ENT these replaceable keys are called traveling keys. A traveling key consists of a private asymmetric key and a public certificate containing a serial number. As per the above section, a higher serial number in a traveling key certificate invalidates any pre-existing traveling key certificates with a lower serial number.

Traveling keys use the above mechanism for key invalidation and removal. The verinym's private key portion is used to sign and create a group of traveling keys. That key is then destroyed, leaving a set of traveling keys that provide the equivalent level of security and the ability to roll over keys as necessary.

In one implementation, a set of traveling keys is produced. The number will vary in practice, but 30 or more should suffice. Additionally, a termination certificate is also created as per the rules above. If the termination certificate is released to any peer nodes in ENT, those peer nodes will no longer accept the existing verinym certificates, and the verinym will need to be renewed using the peer renewal process.

In one implementation the user may store some or all of their traveling keys in a single secure place. In the preferred implementation however, traveling keys will be distributed amongst some group of peers. The peers could be the same peers as used for the peer renewal process, or they could be a different set.

In one implementation, the keys will be distributed for storage (until needed) to peers in a round robin fashion. For example, if there were 3 peers that keys would be distributed to, then peer 1 would receive key with serial 1, peer 2 would receive key 2, etc. This allows the user to contact any peer and get a key with a higher serial number. Since the highest serial number seen in the ENT system is considered the valid key, any peer should be able to produce a more advanced key. In the preferred implementation, the termination certificate is stored with all peers. This makes it accessible to the user from any known peer.

In one implementation, each distributed key would be encrypted with a key known only to the verinym owner. This prevents any peers from gaining access to the verinym credentials at will or if their device or memory storage containing the credentials becomes compromised or stolen. This mechanism would use any of a number of symmetric key cryptographic process to encrypt each traveling key certificate and private key pair. The symmetric key would be the password chosen by the verinym owner.

Operational Considerations of implementing Relational Authorization and Traveling Keys

In the preferred implementation, ENT allows a user to submit their most recent traveling key to any or all roots. Roots store the most valid traveling key observed on the ENT system for a user. In practice, when a user began using a new traveling key, they would submit a copy of that key to the root servers, such that any query by any node to the roots for the most recent key would return that key.

In one implementation, ENT allows a user to update other ENT nodes directly by transmitting their most recent traveling key to those nodes. This is called key promulgation. This is useful when a user has numerous ENT-enabled services that can be contacted directly. In these cases, the user (or some software on their behalf) can contact all of the user's recorded services, and transmit the most recent traveling key directly. ENT nodes are encouraged to keep caches of other ENT node verinyms, specifically if those nodes have relationships. If an ENT node receives a traveling key certificate, and that certificate is newer than an existing certificate for a less valid traveling key, the node should replace the existing key certificate with the newer version. This concept is very useful as it ensures that any services used by a given user have the user's most recent ENT credentials. This shortens the amount of opportunity that an attacker may have for using a compromised traveling key or previous verinym credential. Additionally, depending on a service's security policy it may improve performance.

In one implementation, ENT has multiple data stores located around the internet. Each of these stores contains a list of verinym credentials and traveling keys for some subset of verinyms on the system. A user may use key promulgation with any of these centers. As with any user service, a center receiving a more valid verinym credential or traveling key will replace its existing copy with the more valid one. In practice, data stores will likely service a range of verinym identifiers. Once data store would cover verinym ids 1-1000, another would cover verinym ids 1001-2000, etc. In practice is it likely that multiple data stores cover the same id ranges. In the case where multiple data stores are covering the same verinym id ranges, those stores should communicate successful updates of either the verinym credentials, or traveling keys to other stores covering the same verinym id.

Key promulgation to services is preferred as a first step over the root submission mechanism above as a first step. Key promulgation to a data store is the preferred second step. All steps are recommended in practice and all steps should be accomplished as quickly as possible. In the preferred implementation, services with higher value of loss in the case of a compromise should be contacted before lower value nodes. After all services are updated, the data stores should be updated. Root updates would be accomplished last.

In other implementations, different promulgation techniques could be used. For instance, a peer-to-peer network could be used to search a large number of peers for newer credentials. Many other such topologies and techniques exist.

It is possible to set up levels of security based on the criticality of services provided by a given node.

For instance, a bank using ENT would have a higher requirement for stringent validity checking than a chat site because the cost of loss is higher. Performing stringent tests increases the cost of a transaction in terms of time (latency), bandwidth, and computation by several multiples. Therefore, ENT provides a spectrum of security levels. Validating a verinym consists of two main phases. The first phase is called a Canopy Validation, and consists of validating a number of existing certificates, each signed by a different root. If there are N roots a Full Canopy Validation would be a security check where more than N/2 roots signature chains are confirmed. However, this may be more security than is useful for certain types of transactions. Therefore anywhere between 1 and N/2+1 signature chains must be validated for a given transaction. For high security transactions a full security check should be performed (100% or more trust level as defined in the Group Authority section). For trivial or very low value transactions, a single signature chain check against one root could be accomplished. Note that checking only a single root signature chain could allow an attacker controlling that root to spoof the user. This is mitigated as more root chains are validated, as it reduces the chance that an attacker would have compromised multiple roots. At the Full Canopy Validation level, an attacker would have had to have gained control of more than N/2 nodes; in effect, taking control of the entire ENT system.

The second phase consists of a system-wide search for a verinym credential and a traveling key credential (if used) that is the most valid. If an attacker were to access a service and pass an out of date credential, and the service did not check for the existence of a newer credential, the service would assume that the attackers credential was valid. For high value transactions, the most secure mechanism is to check one of the appropriate data stores for both a valid verinym credential, and a valid traveling key. For low value transactions, however, this step can be either omitted, or performed on a “lazy” basis. A lazy check allows the transaction to continue. However, a check is accomplished asynchronously against the appropriate data store while the transaction is allowed to continue. If the search finds a newer credential and proves that the existing credential used to start the transaction is invalid, the transaction should be terminated and reversed, if possible.

In one implementation, the second phase check can be skipped if a search has already been accomplished within a timely period determined by the user. For instance, the check could be skipped in a previous search had been accomplished within the last 30 minutes.

One preferred implementation uses three security levels. The “simplistic” level check simply performs Canopy Validation against a single root and does not perform the second phase at all. The “basic” level performs a full security check, and then performs a “lazy” search for newer credentials. A “complete” level check performs a full security check and a credential search before a transaction is allowed to continue.

In one implementation, transactions are allowed to be cached. This allows Canopy Validation to be skipped on subsequent transactions, until the verinym credentials or traveling key changes. On the first transaction with a verinym, a service would require a Canopy Validation. However, the check consists entirely to ensure that a majority of roots have vouched for a given verinym. If a verinyms credentials have not changed since that initial transaction, subsequent transactions can use this cached result without needing to perform another Canopy Validation.

Once both security checks have been accomplished, the service can request proof of ownership. This ensures that the user beginning the transaction with the service has the proper private key portion of the traveling key, or if a traveling key is not used, the private key portion matching the public portion found in the verinym. This usually involves a handshaking mechanism such as that found in the TLS standard. This topic is well covered by other sources, and follows the traditional mechanisms found in PKI systems for determining authenticity and establishing private communication channels. In ENT the traveling key may be used, if available. Otherwise, any certificate in the verinym credentials may be used since they all have identical public keys.

In one implementation, when a transaction is initiated the user will transmit to the service the most recent verinym and traveling key information. This may allow the service to process the transaction without needing to contact other services if it is performing a “simplistic” or “basic” security check.

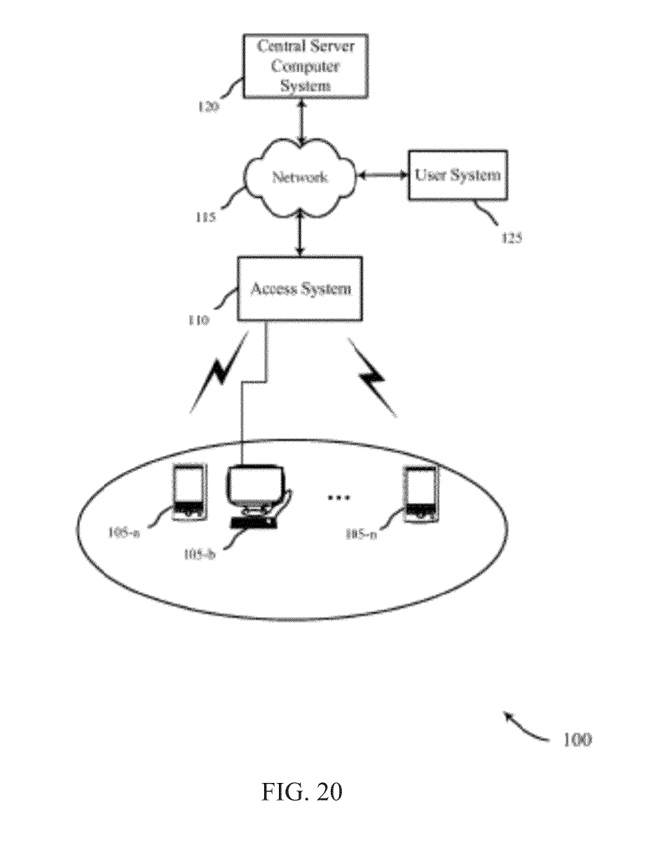

Referring now to FIG. 20, a block diagram illustrates a system 100 according to one embodiment that includes user access terminals 105 that may use the ENT system as described above to access various other systems. A user access terminal 105 may be one of a number of devices, such as a smartphone, a cellular phone, a VoIP phone, a personal digital assistant, a tablet computer, a laptop computer, a portable digital music player, or other mobile device that communicates voice or data, or any combination of the foregoing. A user access terminal 105 may also include a network connected computer system that includes a wired or wireless connection to a local area network, for example. It will be readily understood that a user access terminal may include any suitable device capable of operating to perform the functions for control user access to electronic applications, and the particular components illustrated in FIG. 15 are for purposes of illustration and discussion of general concepts described herein. In various embodiments, the user access terminals 105 are capable of operating according to the above-described examples.

The user access terminals 105, in the embodiment of FIG. 20, connect to an access system 110 either directly or through a network. Such a network may include any suitable network capable of transmitting data on any of a number of different protocols. Such networks are well known and need not be described in further detail here. The access system 110 is interconnected to a network 115 such as, for example, the Internet, which has other network attached components. A central server computer system 120 is connected to the network 115 and, in various embodiments, performs functions related to the ENT system as described above. The central server computer system 120 may, for example, be made up one or more server computers, personal computers, workstations, web servers, or other suitable computing devices, and the individual computing device(s) for a given server may be local or remote from each other. A user system 125 may also be directly connected to the network 115. Such a user system 125 may be another point of user access that may employ systems as described the above.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method for creating a unique identifier for a person, entity, or electronic device, the method implemented within a group authority structure comprising a number (N) of root servers greater than one and comprising the steps of:
receiving, at a first root server, a request from a requester for a unique identifier;
issuing, at the first root server, a first certificate comprising a unique identifier and a policy, wherein the policy comprises one or more other unique identifiers and at least one Boolean operator or mathematical function if the number of other identifiers in the policy is greater than one;
signing, at the first root server, the issued first certificate with a private key from a public/private key pair associated with the root server;
transmitting, from the first root server, the signed issued first certificate, to each other root server;
validating, at each other root server, the abstract unique identifier of the signed issued first certificate;
issuing, at each other root server, an additional certificate comprising the unique identifier and the policy;
signing, at each other root server, the issued additional certificate with a private key from a public/private key pair associated with the respective other root server; and
storing, at a data repository, the signed issued first certificate and the signed issued additional certificates to the requester.

2. The method of claim 1, wherein N is an odd number and each root server signs and operates independently of all other root servers.

3. The method of claim 1, wherein no two root computer servers may issue a same unique identifier to two different requesters.

4. The method of claim 1, wherein each root server is authorized to issue an exclusive range of unique identifiers.

5. The method of claim 1, wherein the signed issued first certificate and the signed issued additional certificates to the requester do not include any description or identification of the requester.

6. The method of claim 1, wherein the abstract unique identifier is considered valid when a number (X) of the signed issued first certificate and the signed issued additional certificates are valid, wherein X=N/2+1.

7. The method of claim 1, wherein the request further comprises the policy.

8. The method of claim 1, further comprising the steps of:
receiving, at the root servers, a renewal request for renewal of the unique identifier in the first issued certificate, wherein the renewal request is signed by each person, entity, or electronic device associated with the other unique identifiers with a private key;
validating, at each root server, the renewal request through execution of the policy in the first issued certificate;
issuing, at each root server, a replacement certificate to replace the first issued certificate;
signing, at each root server, the replacement certificate with a private key from a public/private key pair associated with the respective root server; and
storing, at a data repository, the signed issued replacement certificate.

9. The method of claim 1, wherein the group authority automates enforcement of the policy.

10. The method of claim 1, wherein the first issued certificate comprises a public key or identification of a public key associated with the requester.

11. The method of claim 1, wherein the policy comprises a policy for replacing or updating the unique identifier.

12. The method of claim 1, wherein the policy comprises a policy for authenticating the unique identifier.

13. A method for creating a unique identifier for a person, entity, or electronic device, the method implemented on a server and comprising the steps of:
receiving, at the server, a request from a requester for a unique identifier;
issuing, at the server, a first certificate comprising a unique identifier and a policy, wherein the policy comprises one or more other unique identifiers and at least one Boolean operator or mathematical function if the number of other identifiers in the policy is greater than one;
signing, at the server, the issued first certificate with a private key from a public/private key pair associated with the server; and
storing, at a data repository, the signed issued first certificate.

14. The method of claim 13, wherein the signed issued first certificate does not include any description or identification of the requester.

15. The method of claim 13, wherein the request further comprises the policy.
